(19) United States
(12) Patent Application Publication
(10) Pub. No.: US 2017/0344269 A1
(43) Pub. Date: Nov. 30, 2017

(54) STORAGE SYSTEM, CONTROL APPARATUS, AND METHOD OF TRANSMITTING DATA

(71) Applicant: FUJITSU LIMITED, Kawasaki-shi (JP)

(72) Inventor: Tatsuo Kumano, Kawasaki (JP)

(73) Assignee: FUJITSU LIMITED, Kawasaki-shi (JP)

(21) Appl. No.: 15/495,120

(22) Filed: Apr. 24, 2017

(30) Foreign Application Priority Data
May 27, 2016 (JP) 2016-106306

(51) Int. Cl. G06F 3/06; G06F 12/1009

(52) U.S. Cl. CPC G06F 3/0608; G06F 12/1009; G06F 3/0685; G06F 3/0652; G06F 2212/1044; G06F 2212/657

(57) ABSTRACT

A storage system includes a first storage apparatus configured to execute, when first data stored in a first physical address of the first storage apparatus corresponding to a first logical address is identical with second data stored in a second physical address of the first storage apparatus corresponding to a second logical address, a first redundancy removal processing for erasing the second data and correlating both of the first logical address and the second logical address with the first physical address, and a control apparatus being configured to specify a first read frequency for the first logical address, specify a second read frequency for the second logical address, and execute, when a total value of the first read frequency and the second read frequency is greater than a first value, a transmission of the first data from the first storage apparatus to the second storage apparatus.

### CROSS-REFERENCE TO RELATED APPLICATION

This application is based upon and claims the benefit of priority of the prior Japanese Patent Application No. 2016-106306, filed on May 27, 2016, the entire contents of which are incorporated herein by reference.

### FIELD

The embodiments discussed herein are related to a storage system, a control apparatus and a method of transmitting data.

### BACKGROUND

As an example of a storage system technology, a technology called a “redundancy removal” by which redundant data is not stored in a storing device so as to efficiently use a storage area of the storing device is known. As another example of the storage system technology, a technology called “hierarchization” by which data of which access frequency is high is stored in a storing device which has a high operation speed but is expensive and data of which access frequency is low is stored in a storing device which has a low operation speed but is inexpensive is also known. Japanese Laid-Open Patent Publication No. 2014-041452 and Japanese Laid-Open Patent Publication No. 2011-192259 are examples of the related art.

### SUMMARY

According to an aspect of the invention, a storage system includes a first storage apparatus configured to execute, when first data stored in a first physical address of the first storage apparatus corresponding to a first logical address is identical with second data stored in a second physical address of the first storage apparatus corresponding to a second logical address, a first redundancy removal processing for erasing the second data and correlating both of the first logical address and the second logical address with the first physical address, a second storage apparatus having a second response speed higher than a first response speed of the first storage apparatus, and a control apparatus including a memory and a processor coupled to the memory, the processor being configured to specify a first read frequency for the first logical address, specify a second read frequency for the second logical address, and execute, when a total value of the first read frequency and the second read frequency is greater than a first value, a transmission of the first data from the first storage apparatus to the second storage apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example and a processing example of a storage control apparatus according to a first embodiment;

FIG. 2 is a diagram illustrating a configuration example of a storage system according to a second embodiment;

FIG. 3 is a diagram illustrating an example of a hardware configuration of a server apparatus and a CM;

FIG. 4 is a block diagram illustrating a configuration example of processing functions equipped in the server apparatus and the CM;

FIG. 5 is a diagram illustrating a configuration example of a user volume table;

FIG. 6 is a diagram illustrating configuration examples of a solid state drive(SSD) volume table and a hash table for SSD pool management;

FIG. 7 is a diagram illustrating configuration examples of a hard disk drive (HDD) volume table and a hash table for HDD pool management;

FIG. 8 is a (first) diagram for explaining a first problem;

FIG. 9 is a (second) diagram for explaining the first problem;

FIG. 10 is a diagram for explaining a second problem;

FIG. 11 is a diagram illustrating an outline of control for solving the first problem;

FIG. 12 is a flowchart illustrating an example of an update processing procedure of a number-of-write-times table;

FIG. 13 is a diagram illustrating an outline of control for solving the second problem;

FIG. 14 is a flowchart illustrating an example of a processing procedure in a case where reading of data from a user volume is requested;

FIG. 15 is a flowchart illustrating an example of a write processing procedure into the user volume;

FIG. 16 is a flowchart illustrating an example of a data movement processing procedure from the HDD volume to the SSD volume;

FIG. 17 is a flowchart illustrating an example of a data movement processing procedure from the SSD volume to the HDD volume;

FIG. 18 is a (first) flowchart illustrating an example of a write processing procedure into the SSD volume;

FIG. 19 is a (second) flowchart illustrating the example of the write processing procedure into the SSD volume;

FIG. 20 is a flowchart illustrating an example of a write processing procedure into the HDD volume;

FIG. 21 is a flowchart illustrating an example of a data movement processing procedure in the background; and

FIG. 22 is a diagram illustrating a configuration example of a storage system according to a third embodiment.

### DESCRIPTION OF EMBODIMENTS

As a method for simultaneously using the redundancy removal technique and the hierarchization technique in a storage system, for example, a method in which hierarchization processing is executed first and then, redundancy removal processing is executed may be considered. In this case, for example, when writing of data into a certain logical address of a logical volume is requested from a host apparatus, access frequency to the logical address is determined. In a case where access frequency is low, it is determined that a write destination of data is a low-speed storing device and then, it is determined whether the data is already stored in the low-speed storing device. Although, the data is stored in the low-speed storing device in a case where the data is not stored in the low-speed storing device, data is not stored in the low-speed storing device and a physical address in which the data is stored is correlated with the logical address in a case where the data is stored in the low-speed storing device. On the other hand, in a case where access frequency is high, it is determined that a write destination of data is a high-speed storing device and the redundancy removal processing similarly as in the above-description is executed by regarding the high-speed storing device as a processing target.

However, the method has the following problems. According to the method, in a case where the same piece of data is read from a plurality of logical addresses in a short period of time in a logical volume, it is determined that access frequency in each logical address is low and thus, the pieces of data are stored in the low-speed storing device. A single physical address on the low-speed storing device is allocated to the logical addresses by the redundancy removal processing. For that reason, actually, reading of data from the same physical address on the low-speed storing device is performed a plurality of times. As such, there may be a case where even though actually the piece of data is frequently read, the piece of data becomes in a state of being stored in the low-speed storing device and an access speed becomes low, which is problematic.

In the following, embodiments of the present disclosure will be described with reference to the accompanying drawings.

### First Embodiment

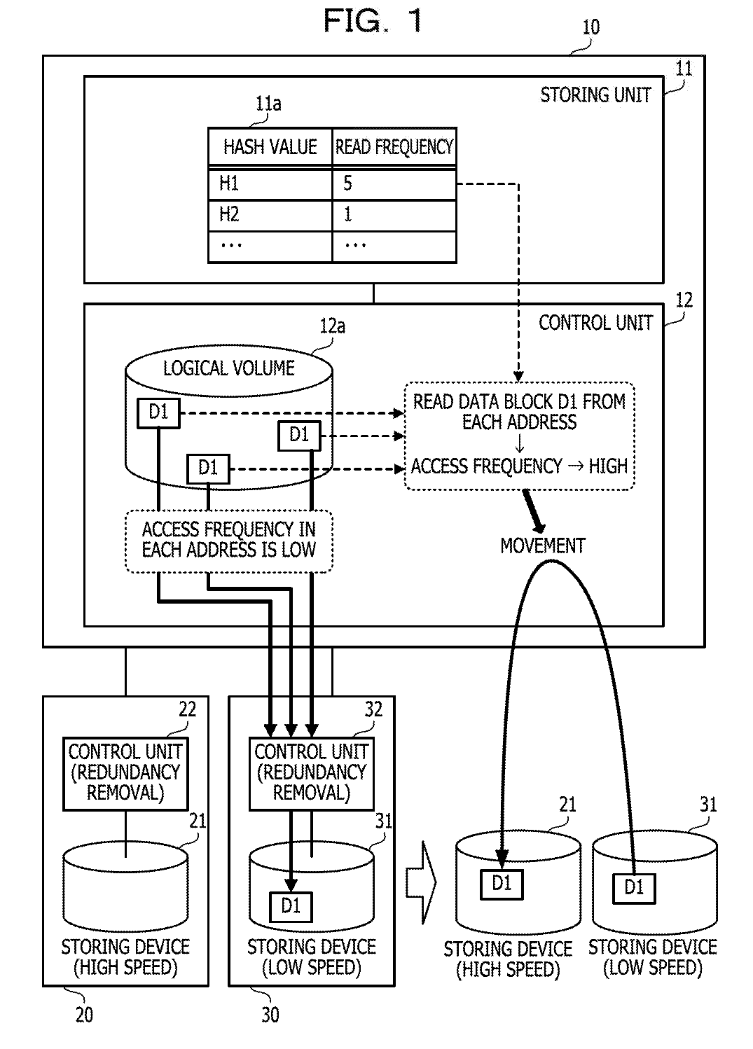

FIG. 1 is a diagram illustrating a configuration example and a processing example of a storage control apparatus according to a first embodiment. A storage control apparatus 10 illustrated in FIG. 1 includes a storing unit 11 and a control unit 12. The storing unit 11 is mounted as, for example, a storage area of a storing device equipped in the storage control apparatus 10. A control unit 12 is mounted as, for example, a processor equipped in the storage control apparatus 10.

The storage control apparatus 10 is able to access storing devices 21 and 31. Data for which redundancy removal is performed is stored in the storing device 21. In an example of FIG. 1, the storing device 21 is installed in a storage apparatus 20 and a control unit 22 installed in the storage apparatus 20 performs redundancy removal and stores data in the storing device 21. The redundancy removal is performed and data is also stored in the storing device 31. In an example of FIG. 1, the storing device 31 is installed in a storage apparatus 30 and a control unit 32 installed in the storage apparatus 30 performs the redundancy removal and stores data in the storing device 31.

Access performance of the storing device 21 is higher than access performance of the storing device 31. In the storage control apparatus 10, a logical volume 12a realized by respective storage areas of the storing devices 21 and 31 is set. The control unit 12 of the storage control apparatus 10 controls access to the logical volume 12a according to a request from a host apparatus (not illustrated).

The storing unit 11 stores read frequency information 11a. In the read frequency information 11a, a hash value based on a data block for which reading is requested from the host apparatus and an index indicating read frequency of the data block, among data blocks written into a logical volume 12a from the host apparatus, are correlated with each other to be registered. That is, in the read frequency information 11a, the hash value and read frequency are maintained in a data block unit having the same contents, regarding data blocks written into the logical volume 12a. In FIG. 1, a hash value H1 is a value calculated based on a data block D1 and a hash value H2 is a value calculated based on a data block D2.

The control unit 12 monitors access frequency in each address of the logical volume 12a. When writing into the logical volume 12a is requested from the host apparatus, the control unit 12 determines a write destination of a data block for which writing is requested as follows. In a case where access frequency to a write destination address is high in the logical volume 12a, the control unit 12 stores the data block in the high-speed storing device 21. On the other hand, in a case where the access frequency to the write destination address is low, the control unit 12 stores the data block in the low-speed storing device 31.

Here, it is assumed that writing of data blocks D1 having the same contents into a plurality of different addresses on the logical volume 12a is requested from the host apparatus. It is assumed that access frequency in each address is determined as being low when a write request into each address is received. In this case, the control unit 12 requests the storage apparatus 30 to write the data block D1, for which writing into each address is requested, into the low-speed storing device 31. The control unit 32 of the storage apparatus 30 performs the redundancy removal and stores the data block D1 in the storing device 31. Accordingly, the data block D1 for which writing into each address on the logical volume 12a is requested is actually stored in a single address of the storing device 31.

In this state, it is assumed that the data block D1 for which reading from each address of the logical volume 12a is requested from the host apparatus. The control unit 12 receives the requested data block D1 from the storage apparatus 30, transmits the data block D1 to the host apparatus, and updates read frequency correlated with the hash value H1 based on the data block D1 in the read frequency information 11a. Reading of the same data block D1 is repeatedly requested and thus, read frequency corresponding to the hash value H1 becomes high.

Here, the data block D1 is read from different addresses of the logical volume 12a in a distributed manner and thus, access frequency in each address does not become high. For that reason, the data block D1 continues to be stored in the low-speed storing device 31 like this. However, the data block D1 is actually stored in only a single address of the storing device 31. For that reason, when the data block D1 remains stored in the storing device 31, the data block D1 is repeatedly read from a single address of the storing device 31. In this case, a reading speed is reduced and processing efficiency is low.

In order to solve such a problem, the control unit 12 executes following processing by referencing the read frequency information 11a. For example, when read frequency correlated with the hash value H1 exceeds a predetermined threshold value at some point in time, the control unit 12 determines that read frequency of the data block D1 corresponding to the hash value H1 becomes higher. Then, the control unit 12 controls the storage apparatuses 20 and 30 such that the data block D1 is moved from the low-speed storing device 31 to the high-speed storing device 21.

When the data block D1 is moved to the storing device 21, due to the redundancy removal by the control unit 22, the data block D1 is stored only in a single address within the high-speed storing device 21. In this state, when reading of the same data block D1 from a plurality of addresses of the logical volume 12a is requested, the data block D1 is repeatedly read from the address within the storing device 21. Accordingly, the reading speed is increased compared to a state where the data block D1 is stored in the low-speed storing device 31.

According to the first embodiment described above, the storage control apparatus 10 manages read frequency in a unit of the data block within the logical volume 12a using read frequency information 11a. When it is determined that the read frequency of the data block D1 becomes higher, the storage control apparatus 10 moves the data block D1 from the low-speed storing device 31 to the high-speed storing device 21. By doing this, it is possible to increase a reading speed in a case where the same data block D1 is read from a plurality of addresses of the logical volume 12a. As a result, it is possible to improve access performance to the logical volume 12a.

### Second Embodiment

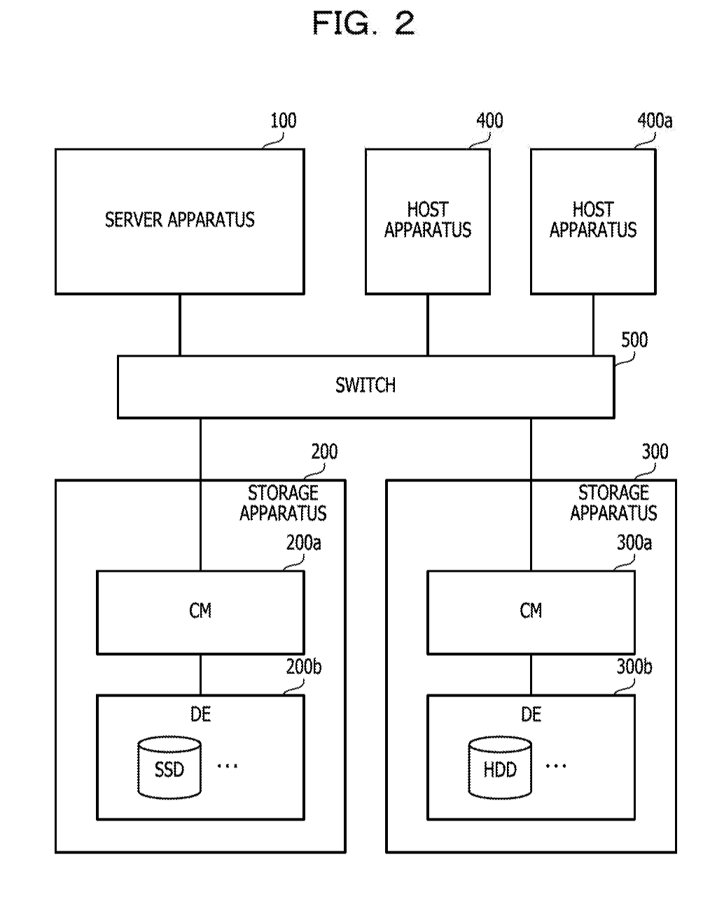

FIG. 2 is a diagram illustrating a configuration example of a storage system according to a second embodiment. A storage system illustrated in FIG. 2 includes a server apparatus 100, storage apparatuses 200 and 300, host apparatuses 400 and 400a, and a switch 500. The server apparatus 100 is an example of the storage control apparatus 10 of FIG. 1 and the storage apparatuses 200 and 300 are examples of the storage apparatuses 20 and 30 of FIG. 1, respectively.

The server apparatus 100 is coupled to the storage apparatuses 200 and 300 through the switch 500. The host apparatuses 400 and 400a are coupled to the server apparatus 100 through the switch 500. A network which couples the apparatuses is a storage area network (SAN) using, for example, a fibre channel (FC) or internet small computer system interface (iSCSI). Only a single host apparatus or three or more host apparatuses may be included in the storage system.

The server apparatus 100 prepares a logical volume (corresponding to a user volume which will be described later) and controls access to the logical volume according to a request from the host apparatuses 400 and 400a. The logical volume is a virtual storage region realized by storage areas provided from the storage apparatuses 200 and 300. The server apparatus 100 transmits data, for which writing into each block on the logical volume is requested, to one of the storage apparatuses 200 and 300 and requests writing of the data.

The storage apparatus 200 includes a controller module (CM) 200a and a drive enclosure (DE) 200b. A plurality of storing devices are installed in the DE 200b. The CM 200a and each storing device within the DE 200b are coupled by, for example, a serial attached SCSI (SAS). The CM 200a controls access to the storing device within DE 200b according to a request from the server apparatus 100.

Similarly, the storage apparatus 300 also includes a CM 300a and a DE 300b. A plurality of storing devices are installed in the DE 300b. The CM 300a and each storing device within the DE 300b are coupled by, for example, the SAS. The CM 300a controls access to the storing device within DE 300b according to a request from the server apparatus 100.

Here, access performance of the storing device installed in the DE 200b is higher than that of the storing device installed in the DE 300b. Accordingly, as a storage area allocatable to a logical volume to be prepared by the server apparatus 100, the storage apparatus 200 provides a high-speed storage area and the storage apparatus 300 provides a low-speed storage area. As an example of the second embodiment, it is assumed that a plurality of SSDs are installed in the device DE 200b and a plurality of HDDs are installed in the device DE 300b.

As will be described later, the server apparatus 100 executes “hierarchization processing” of storing data of a block of which access frequency is high in a high-speed storing device and storing data of a block of which access frequency is low in a low-speed storing device in the logical volume. The CM 200a executes “redundancy removal processing” of controlling the same data so as not to be redundantly stored in the storage area of the DE 200b. The CM 300a executes the “redundancy removal processing” of controlling the same data so as not to be redundantly stored in the storage area of the DE 300b.

The host apparatuses 400 and 400a access the logical volume provided from the server apparatus 100 to thereby execute predetermined processing such as job processing.

The switch 500 relays data transmitted and received between the server apparatus 100 and the storage apparatuses 200 and 300 and between the host apparatuses 400 and 400a and the server apparatus 100.

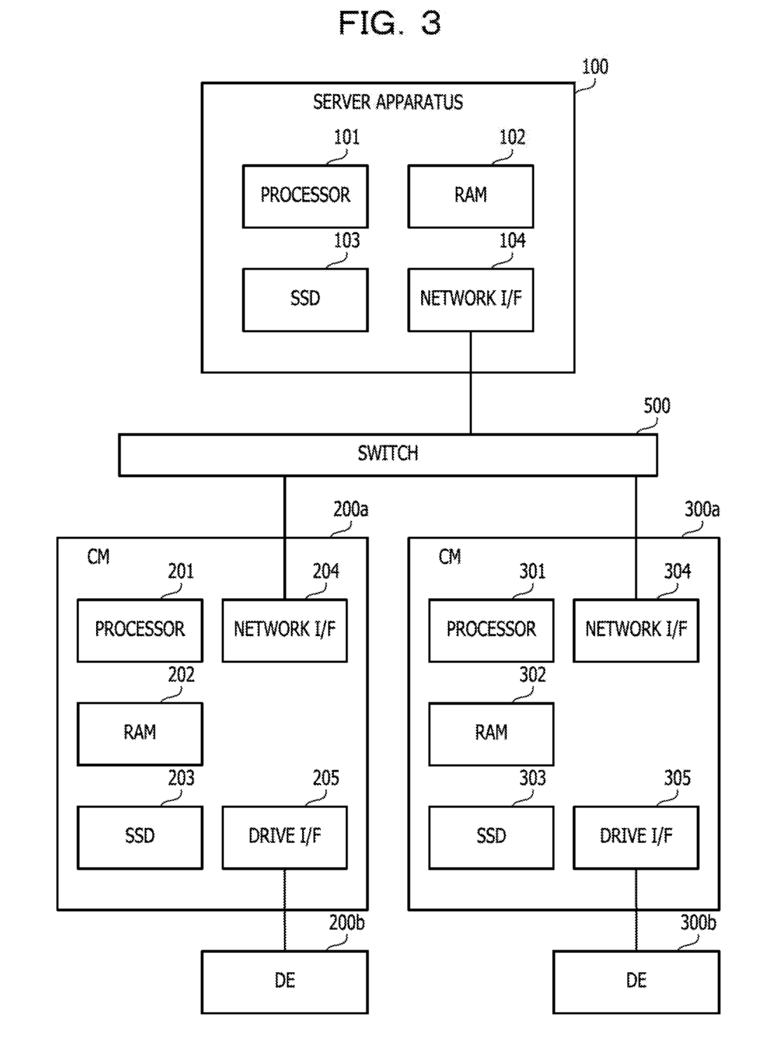

FIG. 3 is a diagram illustrating an example of a hardware configuration of a server apparatus and a CM.

The server apparatus 100 includes a processor 101, a random access memory (RAM) 102, an SSD 103, and a network interface (I/F) 104. These constitutional elements are coupled to each other through a bus (not illustrated).

The processor 101 integrally controls the entirety of the server apparatus 100. The processor 101 is, for example, a central processing unit (CPU), a micro processing unit (MPU), a digital signal processor (DSP), an application specific integrated circuit (ASIC), or a programmable logic device (PLD). The processor 101 may be a combination of two or more elements among the CPU, the MPU, the DSP, the ASIC, and the PLD.

The RAM 102 is used as a main storing device of the server apparatus 100. In the RAM 102, at least a portion of an operating system (OS) program or an application program executed by the processor 101 is temporarily stored. In the RAM 102, various pieces of data to be used for processing by the processor 101 are stored. The SSD 103 is used as an auxiliary storing device of the server apparatus 100. In the SSD 103, an OS program, an application program, and various pieces of data are stored. The network interface 104 communicates with the CMs 200a and 300a and the host apparatuses 400 and 400a through the switch 500.

The CM 200a includes a processor 201, a RAM 202, an SSD 203, a network interface (I/F) 204, and a drive interface (I/F) 205. These constitutional elements are coupled to each other through a bus (not illustrated).

The processor 201 integrally controls the entirety of the CM 200a. Similar to the processor 101, the processor 201 is, for example, the CPU, the MPU, the DSP, the ASIC, or the PLD. The processor 201 may be a combination of two or more elements among the CPU, the MPU, the DSP, the ASIC, and the PLD.

The RAM 202 is used as a main storing device of the CM 200a. In the RAM 202, at least a portion of an OS program or an application program executed by the processor 201 is temporarily stored. In the RAM 202, various pieces of data to be used for processing by the processor 201 are stored. The SSD 203 is used as an auxiliary storing device of the CM 200a. In the SSD 203, an OS program, an application program, and various pieces of data are stored.

The network interface 104 communicates with the server apparatus 100 through the switch 500. The drive interface 205 communicates with the SSD installed in the DE 200b. The drive interface 205 is, for example, a SAS interface.

The CM 300a is realized by hardware similar to that of to the CM 200a. That is, the CM 300a includes a processor 301, a RAM 302, an SSD 303, a network interface (I/F) 304, and a drive interface (I/F) 305. These constitutional elements are couple to each other through a bus (not illustrated). The processor 301, the RAM 302, the SSD 303, the network interface 304, and the drive interface 305 correspond respectively to the processor 201, the RAM 202, the SSD 203, the network interface 204, and the drive interface 205 of the CM 200a and thus, descriptions thereof will be omitted.

Although not illustrated, the host apparatuses 400 and 400a may be realized as, for example, a computer having a hardware configuration similar to that of the server apparatus 100.

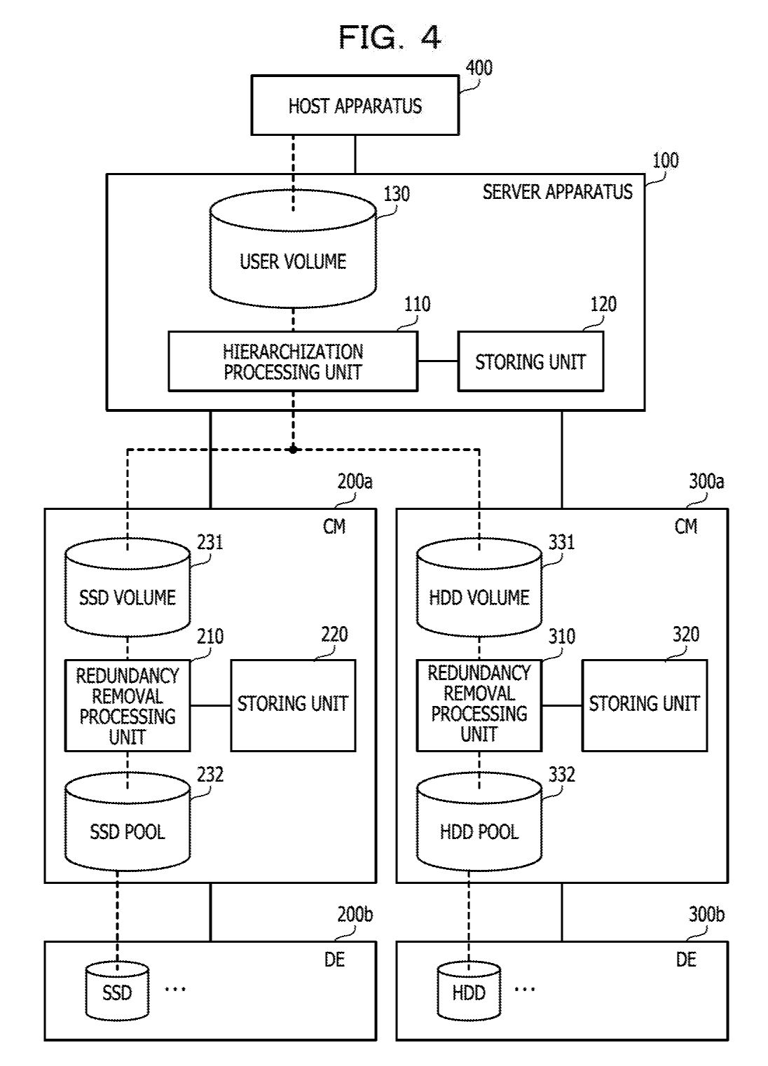

FIG. 4 is a block diagram illustrating a configuration example of processing functions equipped in the server apparatus and the CM.

The server apparatus 100 includes a hierarchization processing unit 110 and a storing unit 120. Processing of the hierarchization processing unit 110 is realized by, for example, allowing a predetermined application program to be executed by the processor 101 of the server apparatus 100. The storing unit 120 is realized by a storage area of the storing device (for example, RAM 102) equipped in the server apparatus 100.

The CM 200a includes a redundancy removal processing unit 210 and a storing unit 220. Processing of the redundancy removal processing unit 210 is realized by, for example, allowing a predetermined application program to be executed by the processor 201 of the CM 200a. The storing unit 220 is realized by a storage area of the storing device (for example, RAM 202) equipped in the CM 200a.

The CM 300a includes a redundancy removal processing unit 310 and a storing unit 320. Processing of the redundancy removal processing unit 310 is realized by, for example, allowing a predetermined application program to be executed by the processor 301 of the CM 300a. The storing unit 320 is realized by a storage area of the storing device (for example, RAM 302) equipped in the CM 300a.

In FIG. 4, a relationship between a logical storage area which is set in the server apparatus 100 and the CMs 200a and 300a and processing functions is also illustrated. As the logical storage area, a user volume 130 is set in the server apparatus 100, an SSD volume 231 and an SSD pool 232 are set in the CM 200a, and an HDD volume 331 and an HDD pool 332 are set in the CM 300a. These logical storage areas are managed by being divided into, for example, blocks of 4 Kbytes, and a logical block address (LBA) is assigned to each block.

The SSD pool 232 is a logical storage area realized by one or more of SSDs within the DE 200b. On the other hand, the HDD pool 332 is a logical storage area realized by one or more of HDDs within the DE 300b. For that reason, access performance of the SSD pool 232 is higher than that of the HDD pool 332.

The SSD pool 232 may be realized by a simple set of storage areas of one or more of SSDs and may be a logical storage area realized by a plurality of SSDs controlled by the redundant array of inexpensive disks (RAID). Also, the HDD pool 332 may be realized by a simple set of storage areas of one or more of HDDs and may be a logical storage area realized by a plurality of HDDs controlled by the RAID.

The SSD volume 231 is a virtual logical storage area realized by storage areas of the SSD pool 232. The HDD volume 331 is a virtual logical storage area realized by storage areas of the HDD pool 332. For that reason, access performance of the SSD volume 231 is higher than that of the HDD volume 331.

The user volume 130 is a virtual logical storage area realized by the SSD volume 231 and the HDD volume 331. It is assumed that the user volume 130 is recognized by, for example, the host apparatus 400 among the host apparatuses 400 and 400a. In the following description, although it is assumed that only a single user volume 130 is set, a plurality of user volumes 130 may be set using a set of the SSD volume 231 and the HDD volume 331.

The host apparatus 400 requests for accessing the user volume 130 to the server apparatus 100 in a block unit. The hierarchization processing unit 110 receives an access request from the host apparatus 400.

When writing of data into a block of the user volume 130 is requested, the hierarchization processing unit 110 requests the redundancy removal processing units 210 and 310 to write the data into the SSD volume 231 and write the data into the HDD volume 331, respectively. In a case where writing of data is requested to the redundancy removal processing unit 310, an LBA of the block of the SSD volume 231 regarded as a write destination of data is notified from the redundancy removal processing unit 210. In a case where writing of data is requested to the redundancy removal processing unit 210, an LBA of the block of the HDD volume 331 regarded as a write destination of data is notified from the redundancy removal processing unit 310. The hierarchization processing unit 110 allocates the notified block to a write request destination block of the user volume 130.

Basically, in a case where access frequency of the write request destination block in the user volume 130 is high, the hierarchization processing unit 110 allocates a block of the SSD volume 231 to the block. On the other hand, in a case where access frequency of the write request destination block in the user volume 130 is low, the hierarchization processing unit 110 allocates a block of the HDD volume 331 to the block. With this, data of the block of which access frequency is high in the user volume 130 is stored in the high-speed storing device.

When reading from the block of the user volume 130 is requested, the hierarchization processing unit 110 designates an LBA of a block of the SSD volume 231 or HDD volume 331 allocated to the block and requests any one of the redundancy removal processing units 210 and 310 to read data of the block. The hierarchization processing unit 110 acquires data of the designated block from any one of the redundancy removal processing units 210 and 310 and transmits the data to the host apparatus 400.

When writing of data into a block of the SSD volume 231 is requested from the hierarchization processing unit 110, the redundancy removal processing unit 210 allocates a block of the SSD pool 232 to the block and stores data in an allocation destination block of the SSD pool 232. In this case, in a case where data for which writing is requested is already stored in the SSD pool 232, the redundancy removal processing unit 210 basically does not store the data and allocates the block in which the same data is already stored in the SSD pool 232 to the write request destination block of the SSD volume 231. With this, pieces of data stored in the SSD pool 232 does not become redundant and use efficiency of the SSD pool 232 is improved.

When reading from the block of the SSD volume 231 is requested from the hierarchization processing unit 110, the redundancy removal processing unit 210 reads data from a block of the SSD pool 232 allocated to the block and outputs the data to the hierarchization processing unit 110.

When writing of data into a block of the HDD volume 331 is requested from the hierarchization processing unit 110, the redundancy removal processing unit 310 allocates a block of HDD pool 332 to the block and stores data in an allocation destination block of the HDD pool 332. In this case, in a case where data for which writing is requested is already stored in the HDD pool 332, the redundancy removal processing unit 310 basically does not store the data and allocates the block in which the same data is already stored in the HDD pool 332 to the write request destination block of the HDD volume 331. With this, pieces of data stored in the HDD pool 332 does not become redundant and use efficiency of the HDD pool 332 is improved.

When reading from the block of the HDD volume 331 is requested from the hierarchization processing unit 110, the redundancy removal processing unit 310 reads data from a block of the HDD pool 332 allocated to the block and outputs the data to the hierarchization processing unit 110.

The storing unit 120 stores various pieces of data used in processing of the hierarchization processing unit 110. For example, the storing unit 120 stores a user volume table for managing the user volume 130. The storing unit 220 stores various pieces of data used in processing of the redundancy removal processing unit 210. For example, the storing unit 220 stores an SSD volume table for managing an SSD volume 231 and a hash table for managing a storage destination of redundant data. The storing unit 320 stores various pieces of data used in processing of the redundancy removal processing unit 310. For example, the storing unit 320 stores a HDD volume table for managing a HDD volume 331 and a hash table for managing a storage destination of redundant data.

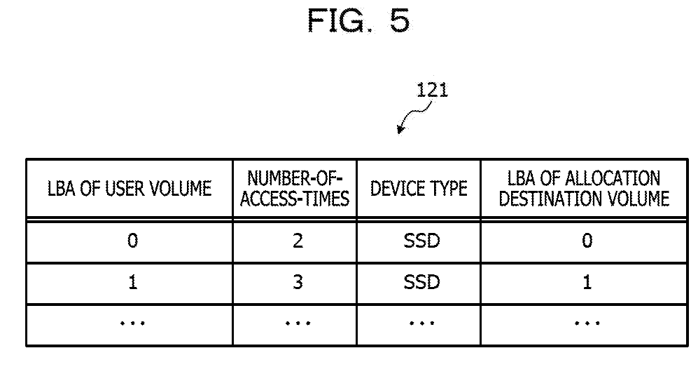

Here, the tables will be described using FIG. 5 to FIG. 7.

FIG. 5 is a diagram illustrating a configuration example of a user volume table. A user volume table 121 illustrated in FIG. 5 is a table for managing a block of the SSD volume 231 or the HDD volume 331 allocated to each block of the user volume 130 and access frequency. The user volume table 121 is stored in the storing unit 120 of the server apparatus 100, updated by the hierarchization processing unit 110 of the server apparatus 100, and referenced by the hierarchization processing unit 110.

In the user volume table 121, records corresponding to all blocks of the user volume 130 are set. The user volume table 121 includes items for an LBA of the user volume 130, the number of access times, a device type, and an LBA of an allocation destination volume.

In the item of the LBA of the user volume 130, an LBA of a block of the user volume 130 is registered. In the item of the number-of-access-times, the number of times of accessing made to the block of the user volume 130 from the host apparatus 400 in the latest predetermined period of time is registered. The number of access times is measured by the hierarchization processing unit 110. The hierarchization processing unit 110 determines, based on the number of access times, whether which block of the SSD volume 231 and the HDD volume 331 is allocated to the block corresponding to the user volume 130.

In the item of the device type, identification information indicating whether which block of the SSD volume 231 and the HDD volume 331 is allocated to the block of the user volume 130 is registered. In a case of the former, a term “SSD” is registered and in a case of the latter, a term “HDD” is registered. In the item of the LBA of the allocation destination volume, the LBA of the block of the SSD volume 231 or the HDD volume 331 allocated to the block of the user volume 130 is registered.

In an initial state immediately after the user volume 130 is prepared, records corresponding to all blocks of the user volume 130 are prepared in the user volume table 121. In this case, items for the number-of-access-times, the device type, and the LBA of the allocation destination volume become empty in each record.

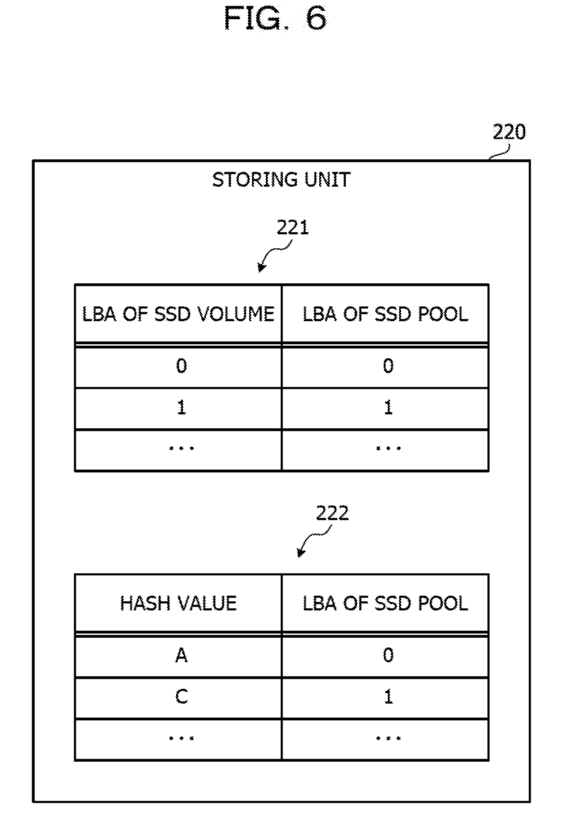

FIG. 6 is a diagram illustrating configuration examples of an SSD volume table and a hash table for SSD pool management. An SSD volume table 221 and a hash table 222 illustrated in FIG. 6 are stored in the storing unit 220 of the CM 200a, are updated by the redundancy removal processing unit 210 of the CM 200a, and are referenced by the redundancy removal processing unit 210.

In the SSD volume table 221, records corresponding to respective blocks, in which data is written, among the blocks of the SSD volume 231 are set. The SSD volume table 221 includes items for an LBA of the SSD volume 231 and an LBA of the SSD pool 232. In the item of the LBA of the SSD volume 231, an LBA of a block of the SSD volume 231 is registered. In the item of the LBA of the SSD pool 232, an LBA of a block of the SSD pool 232 which is allocated to a block of the SSD volume 231 is registered. The blocks of the SSD pool 232 allocated to respective blocks of the SSD volume 231 are managed by the SSD volume table 221.

The hash table 222 is a table used in redundancy removal processing for the SSD pool 232. The hash table 222 includes items for a hash value and an LBA of the SSD pool 232. In the item of the hash value calculated based on data written into the SSD pool 232 is registered. In the item of the LBA of the SSD pool 232, an LBA of a block on the SSD pool 232 in which data corresponding to the hash value is written is registered.

The redundancy removal processing for the SSD pool 232 is executed as in the following using the hash table 222. When the redundancy removal processing unit 210 writes data into a certain block of the SSD volume 231 according to a request from the hierarchization processing unit 110, the redundancy removal processing unit 210 calculates a hash value using a hash function of, for example, secure hash algorithm 1 (SHA-1) based on the data. The redundancy removal processing unit 210 determines whether the calculated hash value is registered in the hash table 222. In a case where the calculated hash value is not registered, the redundancy removal processing unit 210 selects a single empty block of the SSD pool 232 and writes data into the selected empty block. The redundancy removal processing unit 210 correlates an LBA of the selected empty block with the hash value to be registered in the hash table 222 and correlates the LBA with an LBA of a write destination block of the SSD volume 231 to be registered in the SSD volume table 221.

On the other hand, in a case where the calculated hash value is registered in the hash table 222, the redundancy removal processing unit 210 extracts an LBA of the SSD pool 232 correlated with the calculated hash value in the hash table 222. The redundancy removal processing unit 210 does not perform storing of data into the SSD pool 232 and correlates the LBA extracted from the hash table 222 with an LBA of a write destination block of the SSD volume 231 to be registered in the SSD volume table 221.

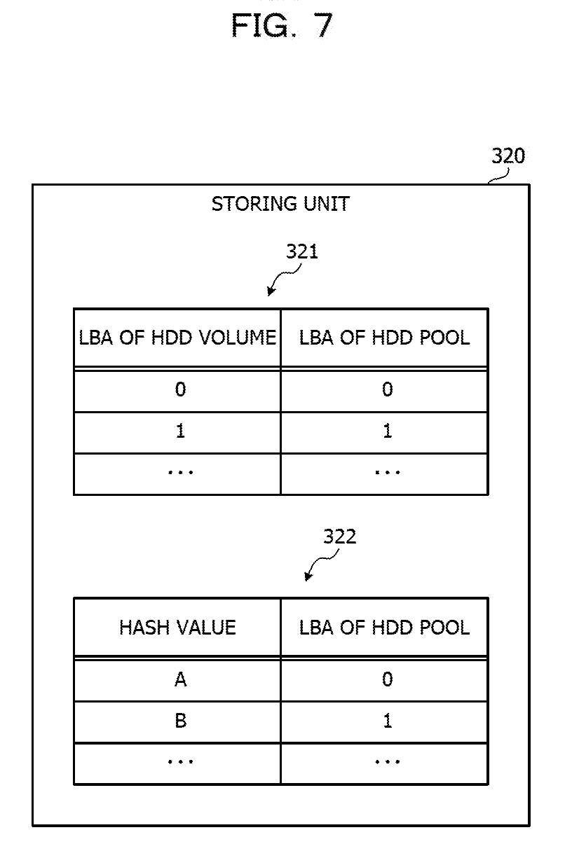

FIG. 7 is a diagram illustrating configuration examples of an HDD volume table and a hash table for HDD pool management. An HDD volume table 321 and a hash table 322 illustrated in FIG. 7 are stored in the storing unit 320 of the CM 300a, are updated by the redundancy removal processing unit 310 of the CM 300a, and are referenced by the redundancy removal processing unit 310.

In the HDD volume table 321, records corresponding to respective blocks, in which data is written, among the blocks of the HDD volume 331 are set. The HDD volume table 321 includes items for an LBA of the HDD volume and an LBA of the HDD pool. In the item of the LBA of the HDD volume 331, an LBA of a block of the HDD volume 331 is registered. In the item of the LBA of the HDD pool 332, an LBA of a block of the HDD pool 332 which is allocated to a block of the HDD volume 331 is registered. The blocks of the HDD pool 332 allocated to respective blocks of the HDD volume 331 are managed by the HDD volume table 321.

The hash table 322 is a table used in redundancy removal processing for the HDD pool 332. The hash table 322 includes items for a hash value and an LBA of the HDD pool 332. In the item of the hash value a hash value calculated based on data written into the HDD pool 332 is registered. In the item of the LBA of the HDD pool 332, an LBA of a block on the HDD pool 332 in which data corresponding to the hash value is written is registered.

The redundancy removal processing for the HDD pool 332 is executed as in the following using the hash table 322. When the redundancy removal processing unit 310 writes data into a certain block of the HDD volume 331 according to a request from the hierarchization processing unit 110, the redundancy removal processing unit 310 calculates a hash value using a hash function of, for example, SHA-1 based on the data. The redundancy removal processing unit 310 determines whether the calculated hash value is registered in the hash table 322. In a case where the calculated hash value is not registered, the redundancy removal processing unit 310 selects a single empty block of the HDD pool 332 and writes data into the selected empty block. The redundancy removal processing unit 310 correlates an LBA of the selected empty block with the hash value to be registered in the hash table 322 and correlates the LBA with an LBA of a write destination block of the HDD volume 331 to be registered in the HDD volume table 321.

On the other hand, in a case where the calculated hash value is registered in the hash table 322, the redundancy removal processing unit 310 extracts an LBA of the HDD pool 332 correlated with the calculated hash value in the hash table 322. The redundancy removal processing unit 310 does not perform storing of data into the HDD pool 332 and correlates the LBA extracted from the hash table 322 with an LBA of a write destination block of the HDD volume 331 to be registered in the HDD volume table 321.

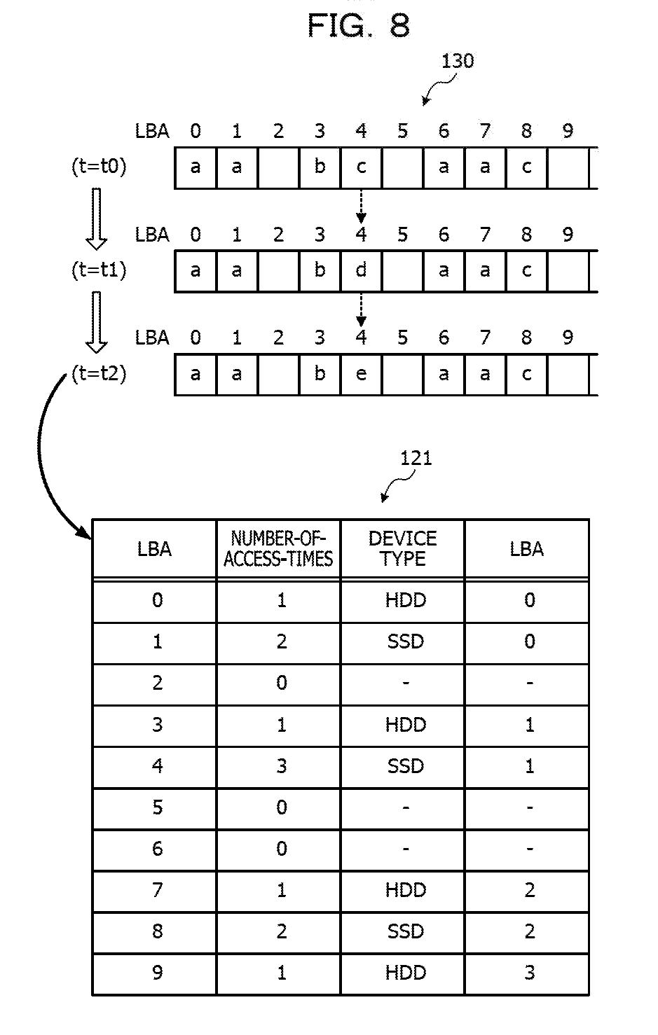

The user volume table 121, the SSD volume table 221, the HDD volume table 321, and the hash tables 222 and 322 described above and illustrated in FIG. 5 to FIG. 7 are basic management information for realizing hierarchization processing and redundancy removal processing. Next, description will be made on a problem in a case where the hierarchization processing and the redundancy removal processing are simply combined using respective tables illustrated in FIG. 5 to FIG. 7 with reference to FIG. 8 to FIG. 10.

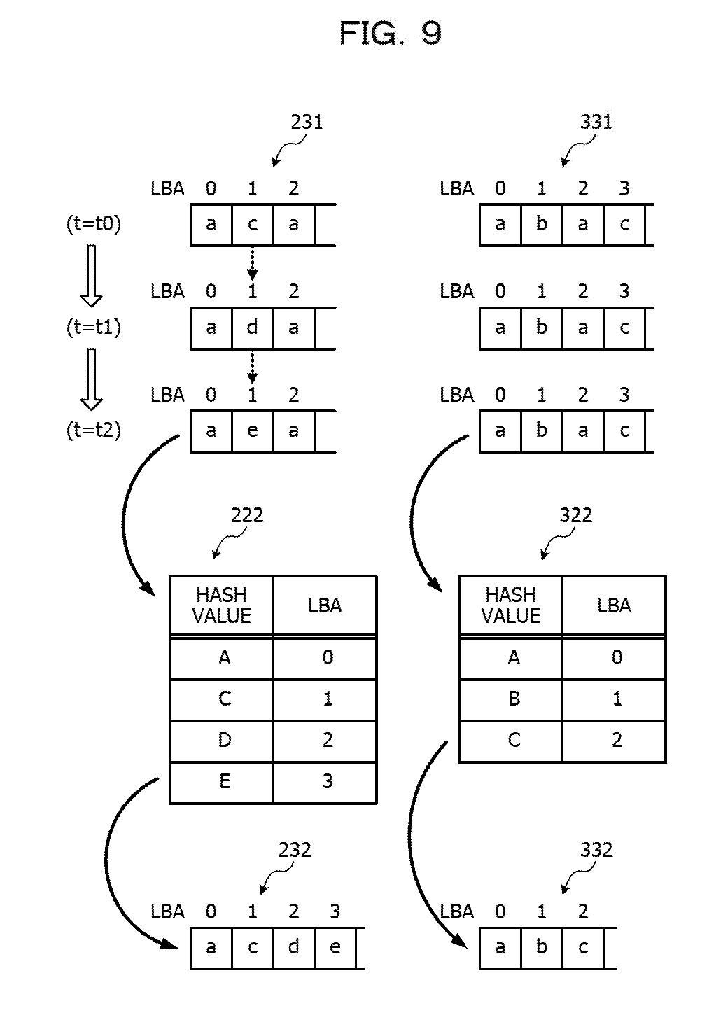

FIGS. 8 and 9 are diagrams for explaining a first problem. As illustrated in the upper side of FIG. 8, it is assumed that writing of data into a block having an LBA “4” of the user volume 130 is successively requested from the host apparatus 400. Specifically, it is assumed that with respect to the block having an LBA “4” of the user volume 130, writing of data c is requested at the time t0, writing of data d is requested at the time t1, and writing of data e is requested at the time t2.

In this case, the hierarchization processing unit 110 determines that access frequency in the block having an LBA “4” of the user volume 130 is high and requests the CM 200a to write data, for which writing into the block is requested, into the SSD volume 231 having high access performance. With this, it is assumed that at the time t2, a block having an LBA “1” of the SSD volume 231 is allocated to the block having an LBA “4” of the user volume 130. In the lower side of FIG. 8, a state of the user volume table 121 at the time t2 is illustrated.

In the upper side of FIG. 9, transitions of states of the SSD volume 231 and the HDD volume 331 at the times t0, t1, and t2 are illustrated. In the lower side of FIG. 9, transitions of states of the SSD pool 232 and the HDD pool 332 at the time t2 are illustrated. In an example of FIG. 9, data of the block having an LBA “1” of the SSD volume 231 is updated with data c, data d, and data e in this order. As such, each time when data of the block having an LBA “1” of the SSD volume 231 is updated with new data, a new block of the SSD pool 232 is allocated to the block. In an example of FIG. 9, blocks having LBAs “1”, “2”, and “3” of the SSD pool 232 are respectively allocated to the block having an LBA “1” of the SSD volume 231 at respective times t0, t1, and t2. With this, pieces of data c, d, and e are respectively stored in the blocks having LBAs “1”, “2”, and “3” of the SSD pool 232.

The hash tables 222 and 322 illustrated in FIG. 9 illustrate states at the time t2. Hash values A, B, C, D, and E are values calculated based on pieces of data a, b, c, d, and e, respectively. In the hash table 222, the LBAs “1”, “2”, and “3” of the SSD pool 232 are respectively correlated with the hash value C based on data c, the hash value D based on data d, and the hash value E based on data e.

As in the examples of FIG. 8 and FIG. 9 described above, in a case where the same block of the user volume 130 is written with data many time, a new block of the SSD pool 232 is used every time writing of data occurs and an use area of the high-speed storing device is increased. In general, the capacity of the high-speed storing device is frequently smaller than that of the low-speed storing device. For that reason, in the case as described above, there is a problem that when processing called “garbage collection” for searching a block capable of being released from the SSD pool 232 of which the capacity is pressed and releasing the block is not executed, the capacity of the SSD pool 232 is pressed and writing of new data is unable to be performed at the early stage.

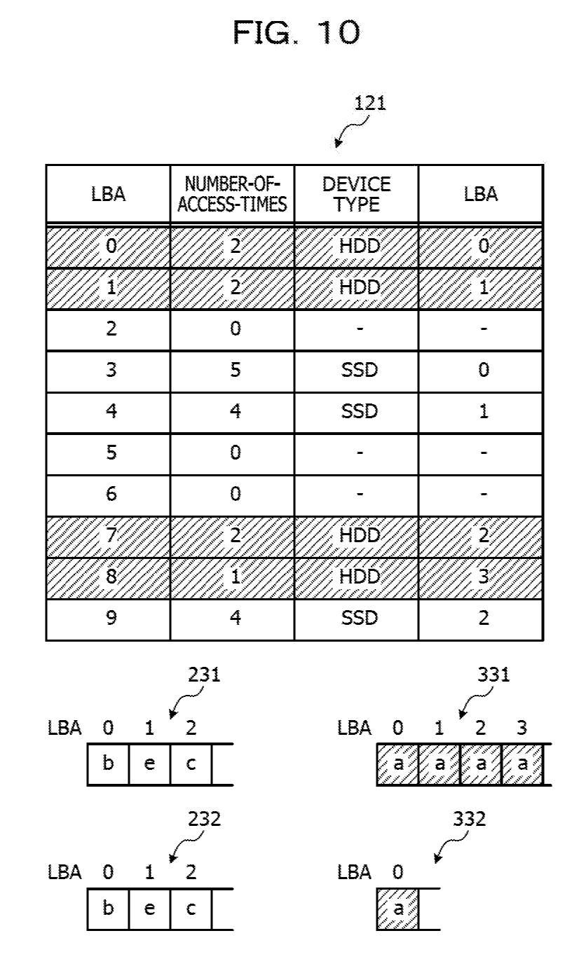

FIG. 10 is a diagram for explaining a second problem. In FIG. 10, it is assumed that the same data a is written into respective blocks having LBAs “0”, “1”, “7”, and “8” of the user volume 130. As illustrated in the user volume table 121 of FIG. 10, it is assumed that the blocks having LBAs “0”, “1”, “2”, and “3” of the HDD volume 331 are respectively allocated to the blocks having LBAs “0”, “1”, “7”, and “8” of the user volume 130. In this state, as illustrated in the lower side of FIG. 10, the same data a is written into the blocks having LBAs “0”, “1”, “2”, and “3” in the HDD volume 331. The data a is actually stored in a single block of the HDD pool 332, specifically, the block having the LBA “0”, by the redundancy removal function of the redundancy removal processing unit 310.

It is assumed that from this state, reading of data a from the blocks having LBAs “0”, “1”, “7”, and “8” of the user volume 130 is requested twice, twice, twice, and once, respectively, in a predetermined period of time. The user volume table 121 of FIG. 10 illustrates the state described above and the number of access times for the blocks having LBAs “0”, “1”, “7”, and “8” of the user volume 130 becomes 2, 2, 2, and 1, respectively.

For example, it is assumed that the hierarchization processing unit 110 allocates the blocks of the high-speed SSD volume 231 to top three blocks, of which the number of access times is high, among the blocks of the user volume 130. In this case, it is determined that the number of access times for the blocks having LBAs “0”, “1”, “7”, and “8” of the user volume 130 is low. As a result, the blocks of the low-speed HDD volume 331 remain allocated to respective blocks. Accordingly, data a remains stored in the block having LBA “0” of the HDD pool 332.

That is, when reading of data a from the respective blocks having LBAs “0”, “1”, “7”, and “8” of the user volume 130 is requested, data a is actually read from the block having the same LBA “0” of the HDD pool 332. As in the case described above, in a case where the same piece of data is successively read from different blocks of the user volume 130, reading from the low-speed storing device is successively performed and a reading speed becomes lower, which is problematic. In the case described above, although it is desirable that data is stored in the high-speed storing device, it is not possible for a simple combination of the hierarchization processing and the redundancy removal processing to allow data to be stored in the high-speed storing device.

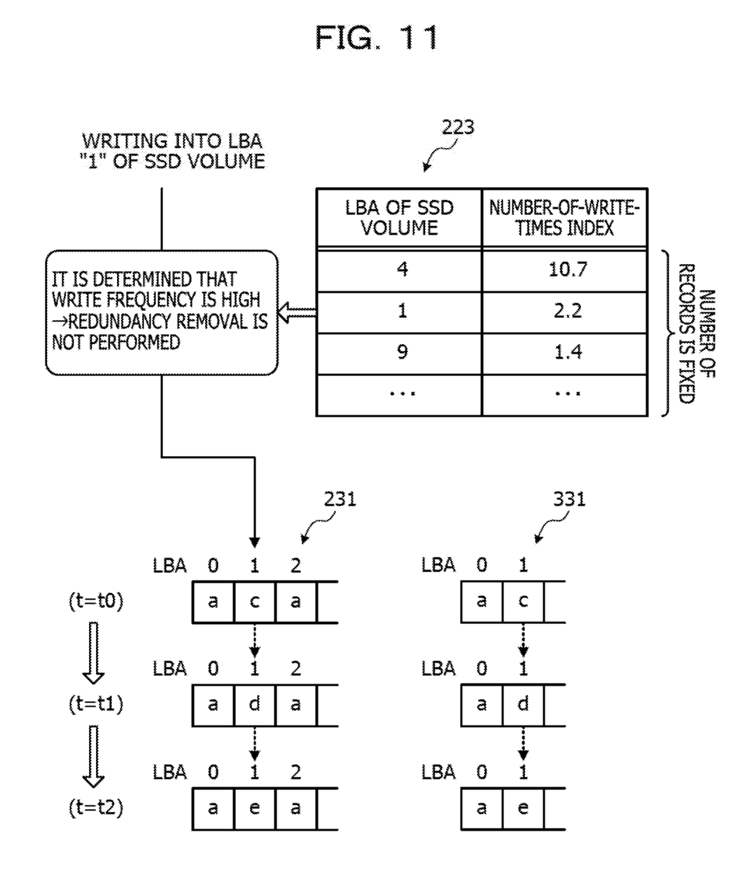

In order to solve such a problem, the server apparatus 100 and the CMs 200a and 300a of the second embodiment perform control illustrated in FIG. 11 to FIG. 13.

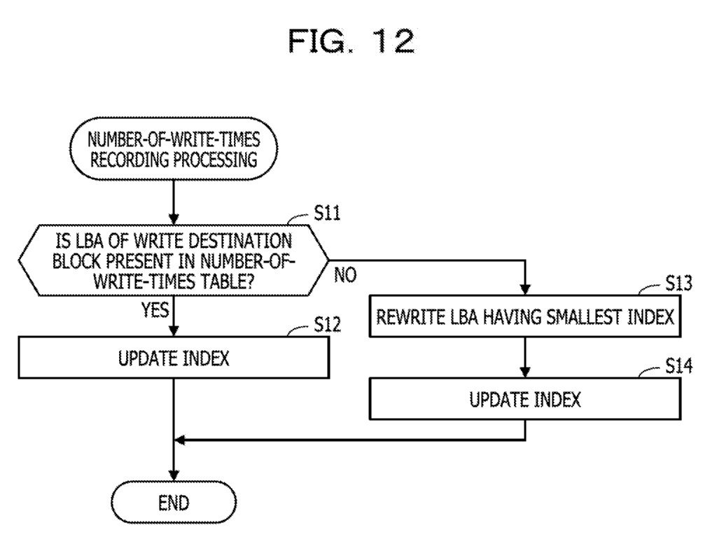

FIG. 11 is a diagram illustrating an outline of control for solving the first problem. In the storing unit 220 of the CM 200a, the number-of-write-times table 223 as illustrated in FIG. 11 is further stored. In the number-of-write-times table 223, a number-of-write-times index indicating the number of times of writing made to an LBA illustrating a block of the SSD volume 231 in the latest predetermined period of time in the block is registered. However, when the number-of-write-times indexes for all blocks of the SSD volume 231 are registered, an amount of data of the number-of-write-times table 223 becomes excessive and the capacity of the storing unit 220 is pressed. In the number-of-write-times table 223, records corresponding to a fixed number of blocks having a high-order number-of-write-times index among the blocks of the SSD volume 231 are registered and the number-of-write-times indexes for these blocks are registered. A specific update method of the number-of-write-times table 223 will be described later with reference to FIG. 12.

When data is written into a certain block of the SSD volume 231 according to a request from the hierarchization processing unit 110, the redundancy removal processing unit 210 determines whether a record corresponding to the block is present in the number-of-write-times table 223. In a case where the record is present, the redundancy removal processing unit 210 determines that write frequency in the latest period of time in the block is high, does not perform the redundancy removal processing, allocates an unique block of the SSD pool 331 to the block, and executes write processing for permitting overwriting of data.

For example, as illustrated in FIG. 11, it is assumed that data c is written into a block having LBA “1” of the SSD volume 231 at the time t0 and LBA “1” of the SSD pool 331 is allocated to the block. It is assumed that from this state, similar to the example of FIG. 9, data d is written into the block having LBA “1” of the SSD volume at the time t1 and data e is written into the same block at the time t2. It is assumed that at either of the times t1 and t2, LBA “1” of the SSD volume is registered in the number-of-write-times table 223 and the block having LBA “1” of the SSD pool 331 is allocated to the block having LBA “1” of the SSD volume 231.

In such a case, the redundancy removal processing unit 210 does not change an allocation destination of the block of the SSD pool 331 to the block having LBA “1” of the SSD volume at the times t1 and t2. That is, the redundancy removal processing unit 210 overwrites the block having LBA “1” of the SSD pool 331 with data d at the time t1 and further overwrites the block having LBA “1” of the SSD pool 331 with data e at the time t2. With this, in a case where updating of data with respect to the same block of the user volume 130 is successively requested, a new block of the SSD pool 331 is not used every time a request occurs. Accordingly, the SSD pool 331 is hardly used up and use efficiency of the SSD pool 331 is improved.

It is assumed that for example, although the block having LBA “1” of the SSD volume is registered in the number-of-write-times table 223 at the time t1, the block having LBA “1” of the SSD pool 331 is allocated to a block other than the block having LBA “1” of the SSD volume 231. In this case, the redundancy removal processing unit 210 allocates a new block (for example, block having LBA “2”) of the SSD pool 331 to the block having LBA “1” of the SSD volume and stores data in the block having LBA “2” of the SSD pool 331. Thereafter, in a case where updating of data with respect to a block having the same LBA “1” of the SSD volume 231 is requested and the LBA “1” of the block is registered in the number-of-write-times table 223, the redundancy removal processing unit 210 overwrites update data onto the block having LBA “2” of the SSD pool 331 allocated to the block.

With this, similar to matters described above, in a case where updating of data with respect to the same block of the user volume 130 is successively requested, a new block of the SSD pool 331 is not used every time a request occurs. Accordingly, use efficiency of the SSD pool 331 is improved.

FIG. 12 is a flowchart illustrating an example of an update processing procedure of the number-of-write-times table. Processing of FIG. 12 is executed when data is written into a certain block (write destination block) of the SSD volume 231.

[Step S11] The redundancy removal processing unit 210 determines whether an LBA of a write destination block is registered in the number-of-write-times table 223. In a case where the LBA of the write destination block is registered, processing of Step S12 is executed and in a case where the LBA is not registered, processing of Step S13 is executed.

[Step S12] The redundancy removal processing unit 210 updates the number-of-write-times index correlated with the write destination block LBA to be registered in the number-of-write-times table 223.

[Step S13] The redundancy removal processing unit 210 selects a record of which the registered number-of-write-times index is the smallest from the number-of-write-times table 223. The redundancy removal processing unit 210 rewrites the LBA of the write destination block with the LBA registered in the selected record.

[Step S14] The redundancy removal processing unit 210 updates the number-of-write-times index registered in the selected record in Step S13.

By processing of Steps S13 and S14 described above, the record corresponding to the write destination block is rewritten with the record, of which the registered number-of-write-times index is the smallest, among the records of the number-of-write-times table 223.

Here, there are following two methods as the update method of the number-of-write-times index in Steps S12 and S14. In the first update method, at either of Steps S12 and S14, the redundancy removal processing unit 210, first, updates the number-of-write-times indexes of all records of the number-of-write-times table 223 by multiplying the indexes by a constant greater than 0 and less than 1 (for example, 0.99). In Step S12, subsequently, the redundancy removal processing unit 210 adds 1 to the number-of-write-times index correlated with the write destination block LBA to be registered in the number-of-write-times table 223. In Step S14, subsequently, the redundancy removal processing unit 210 rewrites 1 with the number-of-write-times index registered in the record selected in Step S13. According to the first update method, the number-of-write-times index in respective records of the number-of-write-times table 223 becomes a value which includes a decimal and is greater than 0.

On the other hand, in the second update method, in Step S12, the redundancy removal processing unit 210 adds 1 to the number-of-write-times index correlated with the write destination block LBA to be registered in the number-of-write-times table 223. In Step S14, the redundancy removal processing unit 210 adds 1 to the number-of-write-times index registered in the record selected in Step S13. According to the second update method, the number-of-write-times index in respective records of the number-of-write-times table 223 becomes an integer greater than or equal to 1.

Either of the first update method and the second update method, by simple processing, is able to turn a state of the number-of-write-times table 223 to a state substantially equal to a state in which a fixed number of LBAs are registered in descending order of the number-of-write-times in the latest predetermined period of time.

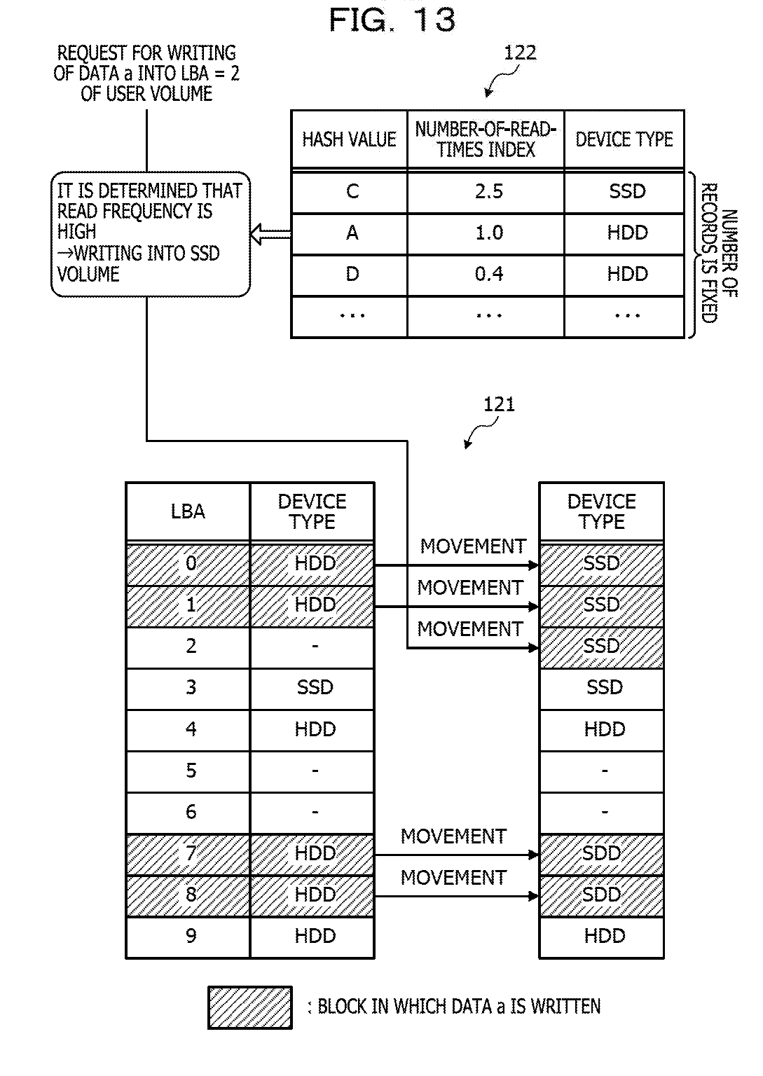

FIG. 13 is a diagram illustrating an outline of control for solving the second problem. In the storing unit 120 of the server apparatus 100, the number-of-read-times table 122 illustrated in FIG. 13 is stored. In the number-of-read-times table 122, a record is registered for each hash value based on data for which writing into the user volume 130 is requested from the host apparatus 400. In each record, the number-of-write-times index indicating the number-of-write-times of corresponding data in the latest predetermined period of time and the device type indicating whether the corresponding data is written into which of the SSD volume 231 and the HDD volume 331 are registered. In the item of the device type, in a case where data is registered in the SSD volume 231, a term “SSD” is registered and in a case where data is registered in the HDD volume 331, a term “HDD” is registered.

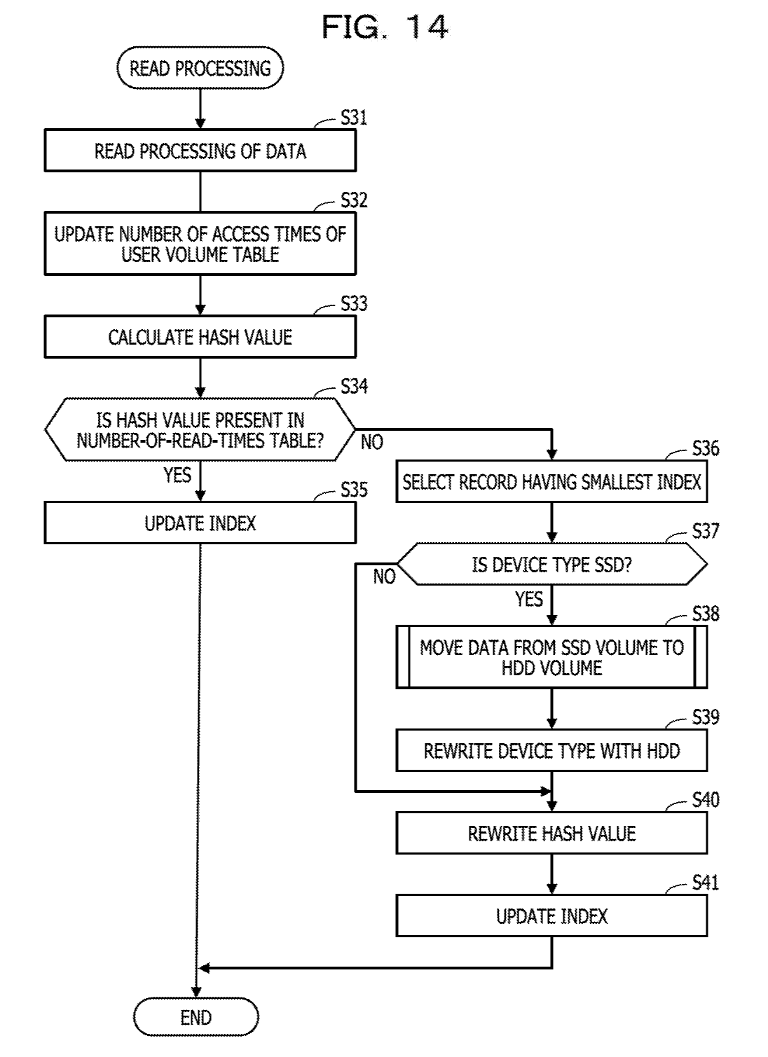

However, when records of the hash values corresponding to all pieces of data for which reading is requested from the host apparatus 400 are registered, an amount of data of the number-of-read-times table 122 becomes excessive and the capacity of the storing unit 120 is pressed, an amount of data of the number-of-write-times table 223 becomes excessive and the capacity of the storing unit 120 is pressed. Here, in the number-of-read-times table 122, only the records regarding the hash values based on a fixed number of pieces of data having a high-order number-of-write-times index, among pieces of data for which reading is requested, are registered by the method similar to that of the number-of-write-times table 223 and the number-of-write-times indexes and the device types corresponding to the hash values are registered. A specific update method of the number-of-read-times table 122 will be described with reference to FIG. 14.

The hierarchization processing unit 110 determines that data corresponding to the hash value registered in the number-of-read-times table 122 is data of which read frequency is high. In a case where such data is written into the low-speed HDD volume 331 according to the device type, the hierarchization processing unit 110 moves data from the HDD volume 331 to the SSD volume 231. With this, in a case where the same data is successively read from different blocks of the user volume 130, the data is stored in the SSD volume 231 and a reading speed of the data is increased.

A plurality of timings of data movement may be considered. For example, there is a method of executing the data movement upon a write request into the user volume 130. FIG. 13 illustrates an example of such case. The user volume table 121 illustrated in the lower left side of FIG. 13 is in a state similar to that of FIG. 10 and the same data a is written into respective blocks having LBAs “0”, “1”, “7”, and “8” of the user volume 130. The blocks of the HDD volume 331 are allocated to the blocks having LBAs “0”, “1”, “7”, and “8” of the user volume 130. In this state, similar to the state of the lower right side of FIG. 10, data a is stored in a single block of the HDD pool 332.

In this state, it is assumed that reading of data a from respective blocks having LBAs “0”, “1”, “7”, and “8” of the user volume 130 is successively requested from the host apparatus 400. In this case, the number-of-write-times regarding data a in the latest predetermined period of time is increased and it becomes a state in which a record including a hash value A based on data a is registered in the number-of-read-times table 122.

In this state, it is assumed that writing of data a into a block having LBA “2” of the user volume 130 is requested from the host apparatus 400. In this case, the hierarchization processing unit 110 calculates the hash value A based on the data a. The calculated hash value A is registered in the number-of-read-times table 122 and thus, the hierarchization processing unit 110 requests the redundancy removal processing unit 210 to write data a into the high-speed SSD volume 231. In this case, as illustrated in the lower right side of FIG. 13, a block of the SSD volume 231 is allocated to the block having LBA “2” of the user volume 130. Together with this, the hierarchization processing unit 110 moves data a of the respective blocks having LBAs “0”, “1”, “7”, and “8” of the user volume 130 which are written in the HDD volume 331 to the SSD volume 231. In the CM 200a, the redundancy removal processing is executed and data a is stored in a single block of the SSD pool 232.

Other than the example described above and illustrated in FIG. 13, data movement may be executed upon update of the number-of-read-times table 122 accompanied by a read request from the user volume 130. Furthermore, the number-of-read-times table 122 is regularly referenced irrespective of a relationship between timings of the write request and the read request and in a case where a piece of data which is written into the HDD volume 331 and of which the number-of-write-times index is high is present, the piece of data may be moved.

Next, description will be made on a processing procedure of the server apparatus 100 and the CMs 200a and 300a using a flowchart.

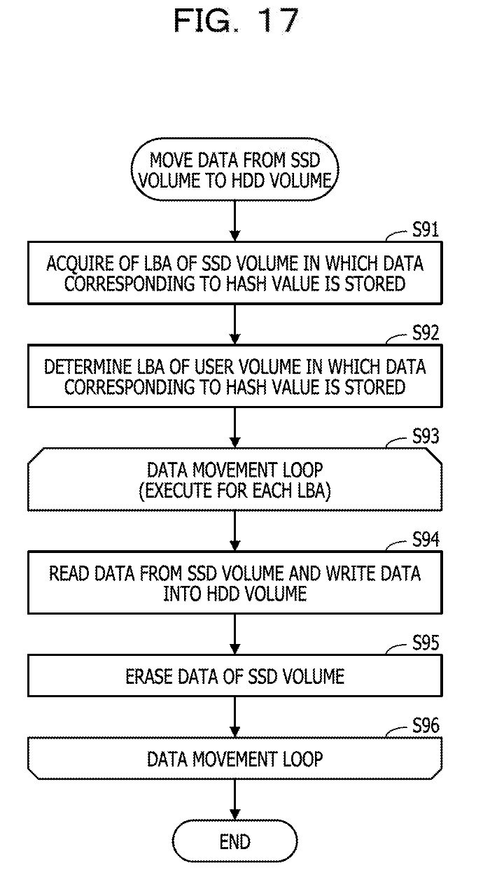

First, FIG. 14 is a flowchart illustrating an example of a processing procedure in a case where reading of data from a user volume is requested.

[Step S31] The hierarchization processing unit 110 of the server apparatus 100 receives a request for reading of data from the user volume 130 made from the host apparatus 400. In this case, an LBA of a read source block in the user volume 130 is designated from the host apparatus 400. The hierarchization processing unit 110 extracts an LBA of a block of the SSD volume 231 or the HDD volume 331 correlated with the read source block from the user volume table 121. The hierarchization processing unit 110 requests the CM 200a or the CM 300a to read data from the block having the extracted LBA. In a case where the block having the extracted LBA is a block of the SSD volume 231, a read request is made to the CM 200a and in a case where the block having the extracted LBA is a block of the HDD volume 331, a read request is made to the CM 300a. When requested data is received from the CM 200a or the CM 300a, the hierarchization processing unit 110 transmits the received data to the host apparatus 400.

[Step S32] The hierarchization processing unit 110 increments the number of access times correlated with the LBA of the read source block of the user volume 130 in the user volume table 121. The number of access times of each record of the user volume table 121 is managed by the hierarchization processing unit 110 such that the number of access times in the latest predetermined period of time is registered.

[Step S33] The hierarchization processing unit 110 calculates the hash value based on data received from the CM 200a or the CM 300a in Step S31.

[Step S34] The hierarchization processing unit 110 determines whether the calculated hash value is registered in the number-of-read-times table 122. In a case where the calculated hash value is registered, processing of Step S35 is executed and in a case where the calculated hash value is not registered, processing of Step S36 is executed.

[Step S35] The hierarchization processing unit 110 updates the number-of-read-times index correlated with the calculated hash value in the number-of-read-times table 122.

[Step S36] The hierarchization processing unit 110 selects the record of which the registered number-of-read-times index is the smallest from the number-of-read-times table 122.

[Step S37] The hierarchization processing unit 110 determines whether the term “SSD” is registered in the item of the device type in the selected record. In a case where the term “SSD” is registered, processing of Step S38 is executed and in a case where the term “HDD” is registered, processing of Step S40 is executed.

[Step S38] The hierarchization processing unit 110 executes processing for moving all pieces of data corresponding to the hash value registered in the selected record among pieces of data written into the SSD volume 231 to the HDD volume 331. In Step S38, all pieces of data corresponding to the hash value deleted from the number-of-read-times table 122 are moved to the low-speed HDD volume 331. Details of processing of Step S38 will be described with reference to FIG. 17.

[Step S39] The hierarchization processing unit 110 rewrites the “HDD” with the item of the device type in the selected record.

[Step S40] The hierarchization processing unit 110 rewrites the hash value calculated in Step S33 with the hash value registered in the selected record.

[Step S41] The hierarchization processing unit 110 updates the number-of-write-times index registered in the selected record.

By processing of Steps S36 to S41 described above, the record corresponding to the hash value based on data for which reading is requested is rewritten with the record, of which the registered number-of-read-times index is the smallest, among the records of the number-of-read-times table 122.

Here, there are following two methods as the update method of the number-of-read-times index in Steps S35 and S41. In the first update method, at either of Steps S35 and S41, the hierarchization processing unit 110, first, updates the number-of-read-times indexes of all records of the number-of-read-times table 122 by multiplying the indexes by a constant greater than 0 and less than 1 (for example, 0.99). In Step S35, subsequently, the hierarchization processing unit 110 adds 1 to the number-of-read-times index correlated with the hash value calculated in Step S33 to be registered in the number-of-read-times table 122. In Step S41, subsequently, the hierarchization processing unit 110 rewrites 1 with the number-of-read-times index registered in the selected record. According to the first update method, the number-of-read-times index in respective records of the number-of-read-times table 122 becomes a value which includes a decimal and is greater than 0. The first update method is characterized in that when the access tendency is changed, it is possible to reflect the latest access tendency and arrange pieces of data without being influenced by information of the past read frequency.

On the other hand, in the second update method, in Step S35, the hierarchization processing unit 110 adds 1 to the number-of-read-times index correlated with the hash value calculated in Step S33 to be registered in the number-of-read-times table 122. In Step S41, the hierarchization processing unit 110 adds 1 to the number-of-read-times index registered in the record selected in Step S36. According to the second update method, the number-of-read-times index in respective records of the number-of-read-times table 122 becomes an integer greater than or equal to 1.

Either of the first update method and the second update method, by simple processing, is able to turn a state of the number-of-read-times table 122 to a state substantially equal to a state in which a fixed number of hash values are registered in descending order of the number-of-read-times in the latest predetermined period of time.

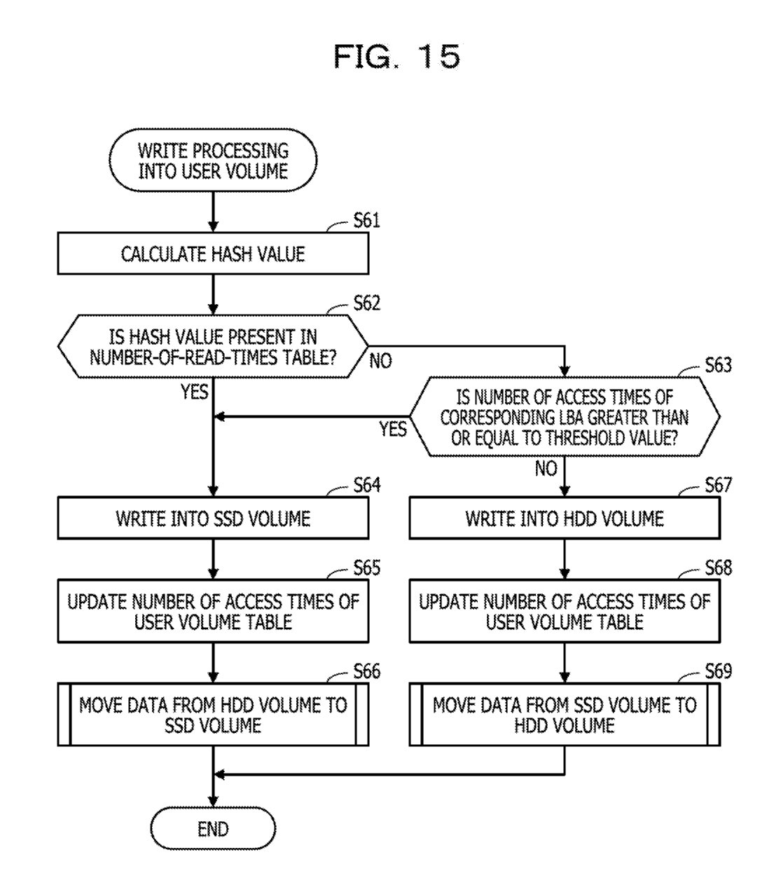

FIG. 15 is a flowchart illustrating an example of a write processing procedure into the user volume.

[Step S61] The hierarchization processing unit 110 of the server apparatus 100 receives a request for writing data into the user volume 130 made from the host apparatus 400. In this case, an LBA of a write source block in the user volume 130 is designated from the host apparatus 400 and write data is transmitted from the host apparatus 400. The hierarchization processing unit 110 calculates the hash value based on received write data.

[Step S62] The hierarchization processing unit 110 determines whether the calculated hash value is registered in the number-of-read-times table 122. In a case where the calculated hash value is registered, processing of Step S64 is executed and in a case where the calculated hash value is not registered, processing of Step S63 is executed.

[Step S63] The hierarchization processing unit 110 extracts the number of access times correlated with the LBA of the write destination block to be registered in the user volume 130 from the user volume table 121. The hierarchization processing unit 110 determines whether the extracted number of access times is greater than or equal to a predetermined threshold value. In a case where the extracted number is greater than or equal to the predetermined threshold value, processing of Step S64 is executed and in a case where the extracted number is less than the predetermined threshold value, processing of Step S67 is executed.

[Step S64] The hierarchization processing unit 110 executes processing of writing write data into the SSD volume 231.

Here, in a case where overwriting of data onto the block, into which writing is completed, is requested from the host apparatus 400, the device type and the LBA of the allocation destination volume are already registered in the record, in which the LBA of the write destination block is registered in the user volume 130, among the records of the user volume table 121. In a case where the device type is the “SSD”, the hierarchization processing unit 110 designates the LBA of the allocation destination volume registered in the record as a write destination and requests the CM 200a to perform writing of write data into the SSD volume 231.

On the other hand, in a case where the device type is the “HDD”, the hierarchization processing unit 110 inquires of the CM 200a about an LBA of an unwritten block of the SSD volume 231. When the LBA of the corresponding block is notified from the redundancy removal processing unit 210 of the CM 200a, the hierarchization processing unit 110 designates the notified LBA as the write destination and requests the CM 200a to perform writing of write data into the SSD volume 231. The hierarchization processing unit 110 extracts the LBA of the allocation destination volume correlated with the LBA of the write destination block of the user volume 130 from the user volume table 121. The hierarchization processing unit 110 designates the extracted LBA and requests the CM 300a to erase data from the HDD volume 331. The redundancy removal processing unit 310 of the CM 300a erases data stored in the block having the LBA designated in the HDD volume 331. The hierarchization processing unit 110 updates the record, in which the LBA of the write destination block is registered in the user volume 130, among the records of the user volume table 121 as follows. The hierarchization processing unit 110 registers the “SSD” in the item of the device type and registers the LBA of the SSD volume 231 notified from the redundancy removal processing unit 210 in the item of the LBA of the allocation destination volume.

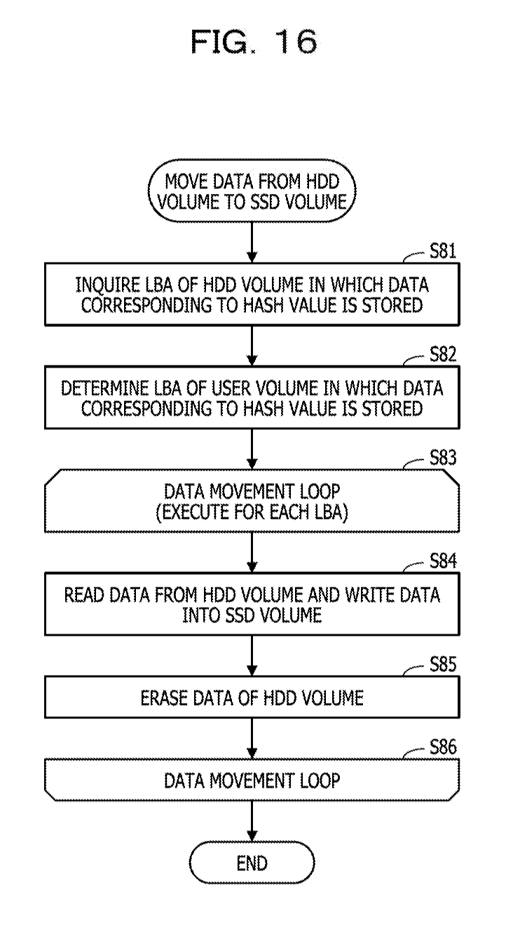

In a case where a request for writing of data into the unwritten block is made from the host apparatus 400, the hierarchization processing unit 110 receives a notification of the LBA of the unwritten block of the SSD volume 231 from the redundancy removal processing unit 210 of the CM 200a in an order similar to that described above. The hierarchization processing unit 110 designates the notified LBA as the write destination and requests the CM 200a to perform writing of write data into the SSD volume 231. The hierarchization processing unit 110 updates the record, in which the LBA of the write destination block is registered in the user volume 130, among the records of the user volume table 121 as follows. The hierarchization processing unit 110 registers the “SSD” in the item of the device type and registers the LBA of the SSD volume 231 notified from the redundancy removal processing unit 210 in the item of the LBA of the allocation destination volume.

[Step S65] The hierarchization processing unit 110 increments the number of access times correlated with the LBA of the write destination block of the user volume 130 in the user volume table 121.

[Step S66] The hierarchization processing unit 110 executes processing of moving all pieces of data corresponding to the hash values calculated in Step S61 among pieces of data written into the HDD volume 331 to the SSD volume 231. Details of the processing will be described with reference to FIG. 16.

[Step S67] The hierarchization processing unit 110 executes processing for writing write data into the HDD volume 331. The processing is similar to processing of changing the write destination from the SSD volume 231 to the HDD volume 331 in Step S64 and thus, detailed description thereof will be omitted.

[Step S68] The hierarchization processing unit 110 increments the number of access times correlated with the LBA of the write destination block of the user volume 130 in the user volume table 121.

[Step S69] The hierarchization processing unit 110 executes processing of moving all pieces of data corresponding to the hash values calculated in Step S61 among pieces of data written into the SSD volume 231 to the HDD volume 331. Details of the processing will be described with reference to FIG. 17.

According to the processing of FIG. 15 described above, in a case where the hash value based on data for which writing is requested from the host apparatus 400 is registered in the number-of-read-times table 122, it is determined that read frequency with respect to data of which contents are the same as the data is high. In this case, write data is written into the SSD volume 231 and data is moved from the HDD volume 331 to the SSD volume 231 also regarding other blocks in which the same piece of data is written in the user volume 130. With this, it is possible to increase the reading speed in a case where the same piece of data is successively read from different blocks on the user volume 130.

FIG. 16 is a flowchart illustrating an example of a data movement processing procedure from the HDD volume to the SSD volume. Processing of FIG. 16 corresponds to, for example, processing of Step S66 of FIG. 15.

[Step S81] The hierarchization processing unit 110 of the server apparatus 100 designates the hash value with respect to the CM 300a and inquires of the CM 300a about an LBA of the block on the HDD volume 331, in which data corresponding to the designated hash value is stored. In a case where processing of FIG. 16 corresponds to Step S66 of FIG. 15, the designated hash value is value calculated in Step S61 of FIG. 15.

The redundancy removal processing unit 310 of the CM 300a retrieves the hash table 322 using the designated hash value and extracts the LBA of the HDD pool 332 correlated with the hash value. Furthermore, the redundancy removal processing unit 310 extracts the LBA of the HDD volume 331 correlated with the extracted LBA from the HDD volume table 321. The redundancy removal processing unit 310 transmits the LBA of the HDD volume 331 extracted from the HDD volume table 321 to the hierarchization processing unit 110 of the server apparatus 100, as a reply of the inquiry described above. The hierarchization processing unit 110 receives the transmitted LBA of the HDD volume 331.

[Step S82] The hierarchization processing unit 110 specifies a record, in which the device type is the “HDD” and the LBA of the allocation destination volume coincides with the LBA of the HDD volume 331 received in Step S81, from the user volume table 121. The LBA of the user volume 130 registered in the specified record indicates a block in which data corresponding to the hash value designated in Step S81 is written. That is, in Step S82, the LBA of the block in which data corresponding to the hash value is written is determined from among the LBAs of the user volume 130.

[Step S83] The hierarchization processing unit 110 repeatedly executes a data movement loop from Step S83 to Step S85 while selecting the LBAs of the user volume 130 determined in Step S82 one by one.

[Step S84] The hierarchization processing unit 110 designates the LBA of the allocation destination volume correlated with the selected LBA and notifies the CM 300a of the designated LBA, and requests the CM 300a to read data from a block of the HDD volume 331 corresponding to the LBA. The requested data is transmitted from the redundancy removal processing unit 310 of the CM 300a.

The hierarchization processing unit 110 requests the CM 200a to write the data received from the CM 300a into the SSD volume 231. The redundancy removal processing unit 210 of the CM 200a executes processing for writing the received data into the empty block of the SSD volume 231 and notifies the hierarchization processing unit 110 of the LBA of the empty block. The hierarchization processing unit 110 updates the LBA of the allocation destination volume, which is correlated with the selected LBA, with the received LBA. The device type correlated with the selected LBA is updated to the “SSD”.

[Step S85] The hierarchization processing unit 110 designates the LBA of the allocation destination volume correlated with the selected LBA and notifies the CM 300a of the designated LBA, and requests the CM 300a to erase data written into the block of the HDD volume 331 corresponding to the LBA. The redundancy removal processing unit 310 of the CM 300a erases the requested data. With this, the movement of corresponding data is completed.

[Step S86] In a case where processing for all LBAs of the user volume 130 determined in Step S82 is finished, the hierarchization processing unit 110 ends the processing.

FIG. 17 is a flowchart illustrating an example of a data movement processing procedure from the SSD volume to the HDD volume. The processing of FIG. 17 corresponds to, for example, processing of Step S38 in FIG. 14 and Step S69 in FIG. 15.

[Step S91] The hierarchization processing unit 110 of the server apparatus 100 designates the hash value and notifies the CM 300a of the designated hash value, and inquires of the CM 200a about the LBA of the block on the SSD volume 231 in which data corresponding to the designated hash value is stored. In a case where the processing of FIG. 17 corresponds to the processing of Step S38 in FIG. 14, the designated hash value is a value calculated in Step S33 of FIG. 14. In a case where the processing of FIG. 17 corresponds to the processing of Step S69 in FIG. 15, the designated hash value is a value calculated in Step S61 of FIG. 15.

The redundancy removal processing unit 210 of the CM 200a retrieves the hash table 222 using the designated hash value and extracts the LBA of the SSD pool 232 correlated with the hash value. Furthermore, the redundancy removal processing unit 210 extracts the LBA of the SSD volume 231 correlated with the extracted LBA from the SSD volume table 221. The redundancy removal processing unit 210 transmits the LBA of the SSD volume 231 extracted from the SSD volume table 221 to the hierarchization processing unit 110 of the server apparatus 100, as a reply of the inquiry described above. The hierarchization processing unit 110 receives the transmitted LBA of the SSD volume 231.

[Step S92] The hierarchization processing unit 110 specifies a record, in which the device type is the “SSD” and the LBA of the allocation destination volume coincides with the LBA of the SSD volume 231 received in Step S91, from the user volume table 121. The LBA of the user volume 130 registered in the specified record indicates a block in which data corresponding to the hash value designated in Step S91 is written. That is, in Step S92, the LBA of the block in which data corresponding to the hash value is written is determined from among the LBAs of the user volume 130.

[Step S93] The hierarchization processing unit 110 repeatedly executes a data movement loop from Step S93 to Step S95 while selecting the LBAs of the user volume 130 determined in Step S92 one by one.

[Step S94] The hierarchization processing unit 110 designates the LBA of the allocation destination volume correlated with the selected LBA and notifies the CM 200a of the designated LBA, and requests the CM 200a to read data from a block of the SSD volume 231 corresponding to the LBA. The requested data is transmitted from the redundancy removal processing unit 210 of the CM 200a.

The hierarchization processing unit 110 requests the CM 300a to write the data received from the CM 200a into the HDD volume 331. The redundancy removal processing unit 310 of the CM 300a executes processing for writing the received data into the empty block of the HDD volume 331 and notifies the hierarchization processing unit 110 of the LBA of the empty block. The hierarchization processing unit 110 updates the LBA of the allocation destination volume, which is correlated with the selected LBA, with the received LBA. The device type correlated with the selected LBA is updated to the “HDD”.

[Step S95] The hierarchization processing unit 110 designates the LBA of the allocation destination volume correlated with the selected LBA and notifies the CM 200a of the designated LBA, and requests the CM 200a to erase data written into the block of the SSD volume 231 corresponding to the LBA. The redundancy removal processing unit 210 of the CM 200a erases the requested data. With this, the movement of corresponding data is completed.

[Step S96] In a case where processing for all LBAs of the user volume 130 determined in Step S92 is finished, the hierarchization processing unit 110 ends the processing.

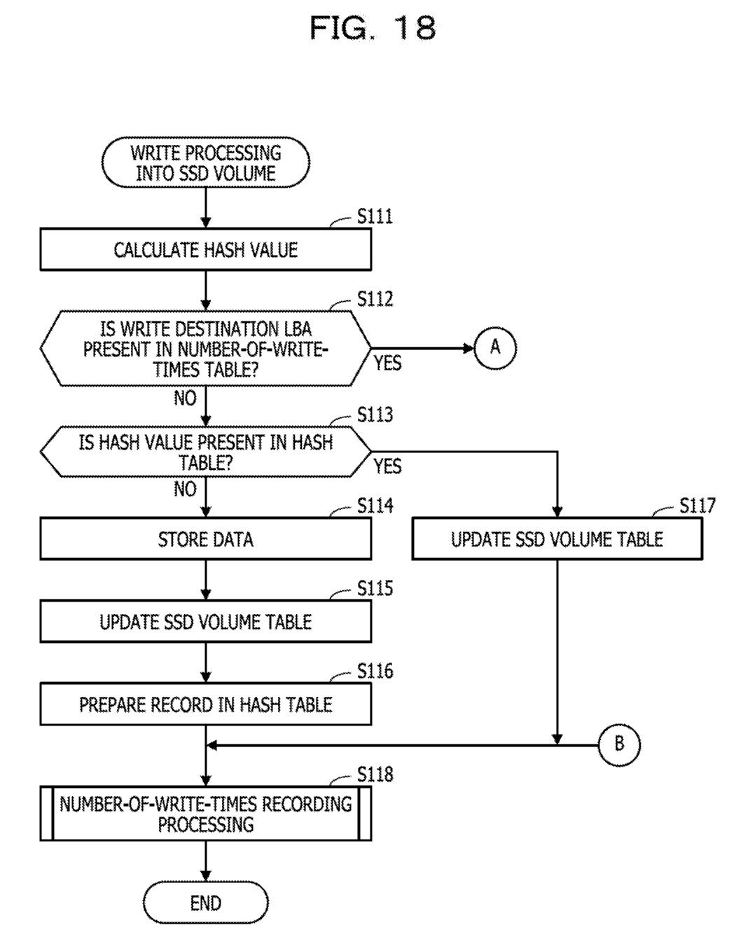

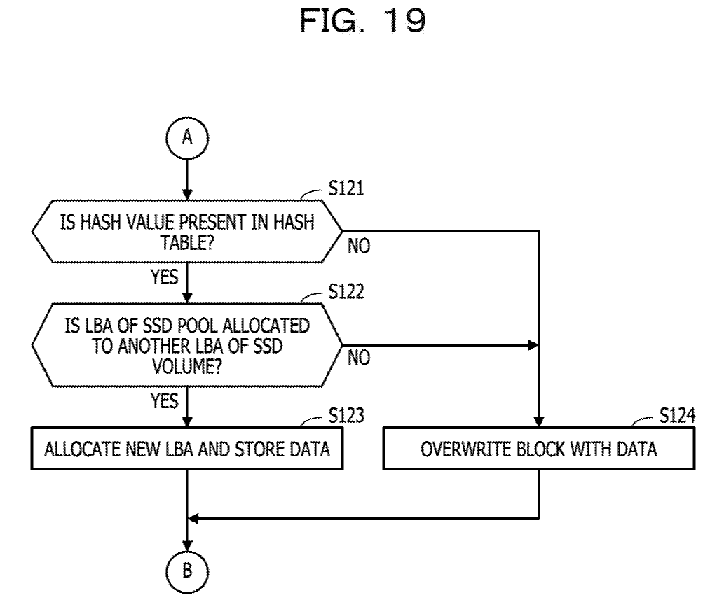

FIG. 18 and FIG. 19 are flowcharts illustrating an example of a write processing procedure into the SSD volume.

[Step S111] The redundancy removal processing unit 210 of the CM 200a receives a request for writing of data into the SSD volume 231 from the hierarchization processing unit 110 of the server apparatus 100. The redundancy removal processing unit 210 calculates the hash value based on data for which writing is requested.

[Step S112] The redundancy removal processing unit 210 determines whether an LBA indicating the block of the write destination in the SSD volume 231 is registered in the number-of-write-times table 223. In a case where the LBA is not registered, processing of Step S113 is executed and in a case where the LBA is registered, processing of Step S121 is executed.

[Step S113] The redundancy removal processing unit 210 determines whether the hash value calculated in Step S111 is registered in the hash table 222. In a case where the hash value is registered, processing of Step S117 is executed and in a case where the hash value is not registered, processing of Step S114 is executed.

[Step S114] The redundancy removal processing unit 210 stores data for which writing is requested in an empty block of the SSD pool 232.

[Step S115] The redundancy removal processing unit 210 updates the SSD volume table 221. Specifically, the redundancy removal processing unit 210 correlates the LBA indicating the block of the write destination with the LBA indicating the block of the SSD pool 232, which stores data in Step S114, in the SSD volume 231 to be registered in the SSD volume table 221.

[Step S116] The redundancy removal processing unit 210 prepares a new record in the hash table 222. The redundancy removal processing unit 210 correlates the hash value calculated in Step S111 with the LBA indicating the block of the SSD pool 232, which stores data in Step S114, to be registered in the prepared record.

[Step S117] In a case where the determination result in Step S113 is Yes, the redundancy removal processing unit 210 does not perform storing of data into the SSD pool 232 and updates the SSD volume table 221. Specifically, the redundancy removal processing unit 210 extracts the LBA of the SSD pool 232 correlated with the hash value calculated in Step S111 from the hash table 222. The redundancy removal processing unit 210 correlates the LBA indicating the block of the write destination in the SSD volume 231 with the LBA of the SSD pool 232 extracted from the hash table 222 to be registered in the SSD volume table 221.

[Step S118] The redundancy removal processing unit 210 executes the number-of-write-times recording processing for updating the number-of-write-times table 223. The number-of-write-times recording processing is the same as matters described in FIG. 12.

[Step S121] The redundancy removal processing unit 210 determines whether the hash value calculated in Step S111 is registered in the hash table 222. In a case where the hash value is registered, processing of Step S122 is executed and in a case where the hash value is not registered, processing of Step S124 is executed.

[Step S122] The redundancy removal processing unit 210 extracts the LBA of the SSD pool 232 correlated with the calculated hash value calculated from the hash table 222. The redundancy removal processing unit 210 retrieves the SSD volume table 221 using the extracted LBA and determines whether the extracted LBA of the SSD pool 232 is allocated to a block other than the block of the write destination in the SSD volume 231. In a case where the extracted LBA is allocated, processing of Step S123 is executed and in a case where the extracted LBA is not allocated, processing of Step S124 is executed.

[Step S123] The redundancy removal processing unit 210 allocates a new LBA indicating an empty block of the SSD pool 232 to the block of the write destination in the SSD volume 231. The redundancy removal processing unit 210 stores data for which writing is requested in the block of the SSD pool 232 indicated by the allocated LBA. The redundancy removal processing unit 210 correlates the LBA of the write destination block in the SSD volume 231 with the newly allocated LBA of the block of the SSD pool 232 to be registered in the SSD volume table 221. Thereafter, processing of Step S118 is executed.

[Step S124] The redundancy removal processing unit 210 extracts the LBA of the SSD pool 232 correlated with the calculated hash value from the hash table 222. The redundancy removal processing unit 210 overwrites data, for which writing is requested, onto the block of the SSD pool 232 indicated by the extracted LBA. Thereafter, processing of Step S118 is executed.

By processing of Steps S121 to S124 described above, the processing described with reference to FIG. 11 is executed. That is, in Step S123, the redundancy removal is not performed and a new block is allocated from the SSD pool 232 as a data write destination. Thereafter, when data of the same block on the SSD volume 231 is further updated by processing of Step S124, a corresponding block is overwritten with data in the SSD pool 232. As such, an unique block is allocated to a block of which the write frequency is high from the SSD pool 232 in the SSD volume 231 and a further piece of update data with respect to the block is stored to thereby make it possible to avoid the situation that empty blocks of the SSD pool 232 are used up in a short period of time. Accordingly, it is possible to increase use efficiency of the SSD pool 232 and improve access performance of the user volume 130.

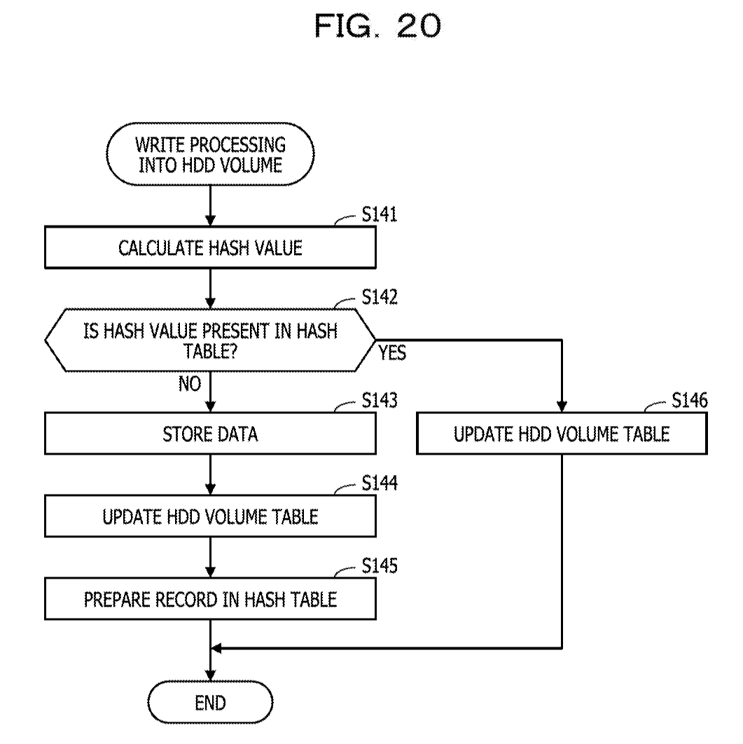

FIG. 20 is a flowchart illustrating an example of a write processing procedure into the HDD volume.

[Step S141] The redundancy removal processing unit 310 of the CM 300a receives a request for writing of data into the HDD volume 331 made from the hierarchization processing unit 110 of the server apparatus 100. The redundancy removal processing unit 310 calculates the hash value based on data for which writing is requested.

[Step S142] The redundancy removal processing unit 310 determines whether the hash value calculated in Step S141 is registered in the hash table 322. In a case where the hash value is registered, processing of Step S146 is executed and in a case where the hash value is not registered, processing of Step S143 is executed.

[Step S143] The redundancy removal processing unit 310 stores data for which writing is requested in an empty block of the HDD pool 332.

[Step S144] The redundancy removal processing unit 310 updates the HDD volume table 321. Specifically, the redundancy removal processing unit 310 correlates the LBA indicating the block of the write destination in the HDD volume 331 with the LBA indicating the block of the HDD pool 332, which stores data in Step S143, to be registered in the HDD volume table 321.

[Step S145] The redundancy removal processing unit 310 prepares a new record in the hash table 322. The redundancy removal processing unit 310 correlates the hash value calculated in Step S141 with the LBA indicating the block of the HDD pool 332, which stores data in Step S143, to be registered in the prepared record.

[Step S146] In a case where the determination result in Step S142 is Yes, the redundancy removal processing unit 310 does not perform storing of data into the HDD pool 332 and updates the HDD volume table 321. Specifically, the redundancy removal processing unit 310 extracts the LBA of the HDD pool 332 correlated with the hash value calculated in Step S141 from the hash table 322. The redundancy removal processing unit 310 correlates the LBA indicating the block of the write destination in the HDD volume 331 with the LBA of the HDD pool 332 extracted from the hash table 322 to be registered in the HDD volume table 321.

In the second embodiment, the movement of data from the HDD volume 331 to the SSD volume 231 is executed based on the number-of-read-times table 122 upon a request for writing of data into the user volume 130. However, data may be moved upon, for example, a request for reading of data from the user volume 130. Otherwise, the movement of data may be executed as background processing irrelevantly to the write request or the read request.

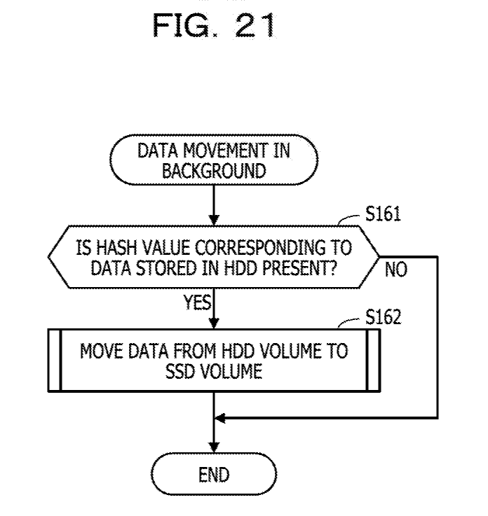

FIG. 21 is a flowchart illustrating an example of a data movement processing procedure in the background. The hierarchization processing unit 110 of the server apparatus 100 regularly executes, for example, following processing.

[Step S161] The hierarchization processing unit 110 references the number-of-read-times table 122 and determines whether a hash value corresponding to data stored in the HDD volume 331, that is, a hash value correlated with the device type “HDD” is present. In a case where the hash value is present, processing of Step S162 is executed and in a case where the hash value is not present, processing is ended.

[Step S162] The hierarchization processing unit 110 executes data movement processing, which is illustrated in FIG. 16, for moving data from the HDD volume 331 to the SSD volume 231, using the hash value in Step S161.

### Third Embodiment

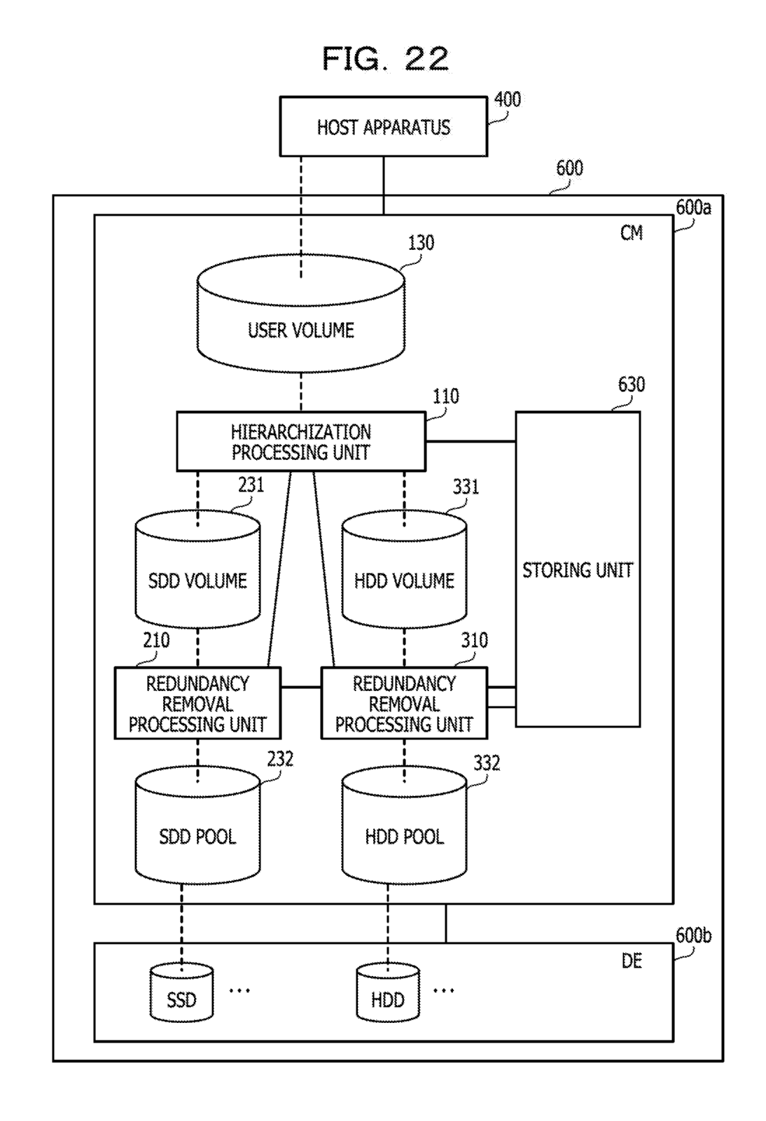

FIG. 22 is a diagram illustrating a configuration example of a storage system according to a third embodiment. In FIG. 22, constitutional elements corresponding to those illustrated in FIG. 4 are denoted by the same reference numerals and descriptions thereof will be omitted.

The storage system illustrated in FIG. 22 includes a storage apparatus 600 and a host apparatus 400. The storage apparatus 600 includes a CM 600a and a DE 600b. One or more SSDs and one or more HDDs are installed in the DE 600b. The CM 600a includes the hierarchization processing unit 110 and the redundancy removal processing units 210 and 310. The CM 600a includes a storing unit 630 to store information stored in the storing units 120, 220, and 320 of FIG. 4.

The CM 600a is realized by the hardware configuration similar to that of the CMs 200a and 300a. Processing of the hierarchization processing unit 110 and the redundancy removal processing units 210 and 310 is realized in such a way that a processor equipped in CM 600a executes, for example, a predetermined application program. The storing unit 630 is realized by a storage area of a storing device equipped in the CM 600a. In the third embodiment, the SSD pool 232 is realized by storage areas of one or more SSDs within the DE 600b and the HDD pool 332 is realized by storage areas of one or more HDDs within the DE 600b.

According to the third embodiment described above, functions of the server apparatus 100 and the CMs 200a, 300a, and 600a of the second embodiment is realized by a single CM 600a.

Processing functions of apparatuses (for example, storage control apparatus 10, server apparatus 100, CMs 200a and 300a) illustrated in respective embodiments described above is able to be realized by a computer. In this case, a program describing processing contents of functions equipped in respective apparatuses is provided and the program is executed by the computer to thereby make it possible to realize the processing functions described above on the computer. The program describing the processing contents is able to be recorded in a computer readable recording medium. The computer readable recording medium may include a magnetic storing device, an optical disk, a magneto-optical recording medium, a semiconductor memory and the like. The magnetic storing device may include a hard disk drive (HDD), a flexible disk (FD), a magnetic tape and the like. The optical disk may include a digital versatile disc (DVD), a DVD-RAM, a compact disc-read only memory (CD-ROM), a CD-R (Recordable)/RW (ReWritable) and the like. The magneto-optical recording medium may include a magneto-optical (MO) disk and the like.

In a case where a program is distributed, for example, a portable recording medium such as a DVD or a CD-ROM in which the program is recorded is sold. A program may be stored in a storing device of a server computer and the program may be transferred from the server computer to another computer trough the network.

A computer which executes a program stores the program recorded in the portable recording medium or the program transferred from the server computer in a storing device of the computer. The computer reads the program from the storing device of the computer and executes processing in accordance with the program. The computer may read the program directly from the portable recording medium and execute processing in accordance with the program. The computer may sequentially execute processing in accordance with the received program each time when a program is transferred from the server computer coupled through the network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage system comprising:
a first storage apparatus configured to execute, when first data stored in a first physical address of the first storage apparatus corresponding to a first logical address is identical with second data stored in a second physical address of the first storage apparatus corresponding to a second logical address, a first redundancy removal processing for erasing the second data and correlating both of the first logical address and the second logical address with the first physical address;
a second storage apparatus having a second response speed higher than a first response speed of the first storage apparatus; and
a control apparatus including a memory and a processor coupled to the memory, the processor being configured to:
specify a first read frequency for the first logical address,
specify a second read frequency for the second logical address, and
execute, when a total value of the first read frequency and the second read frequency is greater than a first value, a transmission of the first data from the first storage apparatus to the second storage apparatus.

2. The storage system according to claim 1, wherein the processor is further configured to:
correlate a first hash value of the first data with the first read frequency for the first logical address,
correlate a second hash value of the second data with the second read frequency for the second logical address, and
determine, when the first hash value is identical with the second hash value, that the first data is identical with the second data.

3. The storage system according to claim 1, wherein the second storage apparatus is configured to execute, when third data stored in a third physical address of the second storage apparatus corresponding to a third logical address is identical with fourth data stored in a fourth physical address of the second storage apparatus corresponding to a fourth logical address, a second redundancy removal processing for erasing the fourth data and correlating both of the third logical address and the fourth logical address with the third physical address.

4. The storage system according to claim 3, wherein the processor is further configured to:
specify a third read frequency for the third logical address,
specify a fourth read frequency for the fourth logical address, and
execute, when a total value of the third read frequency and the fourth read frequency is less than a second value, a transmission of the third data from the second storage apparatus to the first storage apparatus.

5. The storage system according to claim 1, wherein the processor is configured to:
in the transmission, store the first data in a third physical address of the second storage apparatus, and
correlate the first logical address and the second logical address with the third physical address.

6. The storage system according to claim 1, wherein
the first storage apparatus is a hard disk drive (HDD), and
the second storage apparatus is a solid state drive (SSD).

7. The storage system according to claim 2, wherein the processor is configured to:
specify the first logical address based on the first hash value,
read the first data based on the first logical address, and
in the transmission, transmit the first data to the second storage apparatus.

8. The storage system according to claim 3, wherein the processor is further configured to:
when a request for writing of fifth data into a fifth logical address of which an access frequency is higher than a third value, determine a sixth address of the second storage apparatus as a write destination of the fifth data,
when a write frequency regarding the sixth address is lower than a fourth value, execute the second redundancy removal processing for the fifth data and store the fifth data for which the second redundancy processing is executed in the second storage apparatus, and
when the write frequency regarding the sixth address is higher than the fourth value and the sixth data is already stored in a seventh address of the second storage apparatus, store the fifth data in an eighth address of the second storage apparatus.

9. A control apparatus for a first storage apparatus and a second storage apparatus, the first storage apparatus being configured to execute, when first data stored in a first physical address of the first storage apparatus corresponding to a first logical address is identical with second data stored in a second physical address of the first storage apparatus corresponding to a second logical address, a first redundancy removal processing for erasing the second data and correlating both of the first logical address and the second logical address with the first physical address, the second storage apparatus having a second response speed higher than a first response speed of the first storage apparatus, the control apparatus comprising:
a memory; and
a processor coupled to the memory and configured to:
specify a first read frequency for the first logical address,
specify a second read frequency for the second logical address, and
execute, when a total value of the first read frequency and the second read frequency is greater than a first value, a transmission of the first data from the first storage apparatus to the second storage apparatus.

10. The control apparatus according to claim 9, wherein the processor is further configured to:
correlate a first hash value of the first data with the first read frequency for the first logical address,
correlate a second hash value of the second data with the second read frequency for the second logical address, and
determine, when the first hash value is identical with the second hash value, that the first data is identical with the second data.

11. The control apparatus according to claim 9, wherein the second storage apparatus is configured to execute, when third data stored in a third physical address of the second storage apparatus corresponding to a third logical address is identical with fourth data stored in a fourth physical address of the second storage apparatus corresponding to a fourth logical address, a second redundancy removal processing for erasing the fourth data and correlating both of the third logical address and the fourth logical address with the third physical address.

12. The control apparatus according to claim 11, wherein the processor is further configured to:
specify a third read frequency for the third logical address,
specify a fourth read frequency for the fourth logical address, and
execute, when a total value of the third read frequency and the fourth read frequency is less than a second value, a transmission of the third data from the second storage apparatus to the first storage apparatus.

13. The control apparatus according to claim 9, wherein the processor is configured to:
in the transmission, store the first data in a third physical address of the second storage apparatus, and
correlate the first logical address and the second logical address with the third physical address.

14. The control apparatus according to claim 9, wherein
the first storage apparatus is a hard disk drive (HDD), and
the second storage apparatus is a solid state drive (SSD).

15. The control apparatus according to claim 10, wherein the processor is configured to:
specify the first logical address based on the first hash value,
read the first data based on the first logical address, and
in the transmission, transmit the first data to the second storage apparatus.

16. The control apparatus according to claim 11, wherein the processor is further configured to:
when a request for writing of fifth data into a fifth logical address of which an access frequency is higher than a third value, determine a sixth address of the second storage apparatus as a write destination of the fifth data,
when a write frequency regarding the sixth address is lower than a fourth value, execute the second redundancy removal processing for the fifth data and store the fifth data for which the second redundancy processing is executed in the second storage apparatus, and
when the write frequency regarding the sixth address is higher than the fourth value and the sixth data is already stored in a seventh address of the second storage apparatus, store the fifth data in an eighth address of the second storage apparatus.

17. A method of transmitting data using a first storage apparatus and a second storage apparatus having a second response speed higher than a first response speed of the first storage apparatus, the method comprising:
executing, by a first storage apparatus, when first data stored in a first physical address of the first storage apparatus corresponding to a first logical address is identical with second data stored in a second physical address of the first storage apparatus corresponding to a second logical address, a first redundancy removal processing for erasing the second data and correlating both of the first logical address and the second logical address with the first physical address;
specifying a first read frequency for the first logical address;
specifying a second read frequency for the second logical address; and
executing, when a total value of the first read frequency and the second read frequency is greater than a first value, a transmission of the first data from the first storage apparatus to the second storage apparatus.

18. The method according to claim 17, further comprising:
correlating a first hash value of the first data with the first read frequency for the first logical address;
correlating a second hash value of the second data with the second read frequency for the second logical address; and
determining, when the first hash value is identical with the second hash value, that the first data is identical with the second data.

19. The method according to claim 17, wherein the second storage apparatus is configured to execute, when third data stored in a third physical address of the second storage apparatus corresponding to a third logical address is identical with fourth data stored in a fourth physical address of the second storage apparatus corresponding to a fourth logical address, a second redundancy removal processing for erasing the fourth data and correlating both of the third logical address and the fourth logical address with the third physical address.

20. The method according to claim 19, further comprising:
specifying a third read frequency for the third logical address;
specifying a fourth read frequency for the fourth logical address; and
executing, when a total value of the third read frequency and the fourth read frequency is less than a second value, a transmission of the third data from the second storage apparatus to the first storage apparatus.
